(19) United States
(12) Patent Application Publication
(10) Pub. No.: US 2022/0101750 A1
(43) Pub. Date: Mar. 31, 2022

(54) Play Device for Teaching Software Coding Concepts

(71) Applicant: Sarah & Eddie Ventures LLC, Chicago, IL (US)

(72) Inventors: Adnan M. Obissi, Chicago, IL (US); Sarah G. Obissi, Chicago, IL (US)

(21) Appl. No.: 17/033,792

(22) Filed: Sep. 27, 2020

(51) Int. Cl. G09B 19/00; G09B 1/32; G09B 5/12

(52) U.S. Cl. CPC G09B 19/0053; G09B 5/12; G09B 1/325

(57) ABSTRACT

An example play device for teaching software concepts is provided. The play device includes a sensor and a computing device. The play device performs a set of functions. The functions include providing an instruction to place one or more physical objects in an area of the play device. The instruction includes an indication of a source code operator. The functions include determining that a physical object has been placed in the area of the play device. The functions include executing an operation corresponding to the source code operator. The functions include determining, based on executing the operation, whether the instruction is successfully followed in accordance with the source code operator. The functions include providing an indication of (i) a result of executing the operation corresponding to the source code operator, and (ii) whether the instruction is successfully followed in accordance with the source code operator.

### BACKGROUND

Systems and methods described herein relate to software education. In particular, the described systems and methods relate to a play device configured to teach software coding concepts.

Some systems and methods for software education are configured for teaching software coding concepts using a general-purpose computing device with a software application. These implementations may subject children to undesirable screen time and may require an established proficiency in human language that some children do not yet have.

What is needed is a play device that makes learning software coding concepts engaging and attainable for young learners.

### SUMMARY

Example systems and methods relate to software education using a play device.

In a first example, a method for teaching software concepts is provided. The method includes providing an instruction to place one or more physical objects in an area of a play device. The instruction includes an indication of a source code operator. The method includes determining, by a computing device based on sensor data from a sensor of the play device, that a physical object has been placed in the area of the play device. The method includes, responsive to determining that the physical object has been placed in the area of the play device, executing, by the computing device, an operation corresponding to the source code operator. The method includes determining, by the computing device based on executing the operation, whether the instruction is successfully followed in accordance with the source code operator. The method includes providing an indication of (i) a result of executing the operation corresponding to the source code operator, and (ii) whether the instruction is successfully followed in accordance with the source code operator.

In a second example, a play device for teaching software concepts is provided. The play device includes a sensor and a computing device. The computing device includes one or more processors and a non-transitory computer readable medium having instructions stored thereon that when executed by the one or more processors cause performance of a set of functions. The functions include providing an instruction to place one or more physical objects in an area of the play device. The instruction includes an indication of a source code operator. The functions include determining, based on sensor data from the sensor, that a physical object has been placed in the area of the play device. The functions include, responsive to determining that the physical object has been placed in the area of the play device, executing an operation corresponding to the source code operator. The functions include determining, based on executing the operation, whether the instruction is successfully followed in accordance with the source code operator. The functions include providing an indication of (i) a result of executing the operation corresponding to the source code operator, and (ii) whether the instruction is successfully followed in accordance with the source code operator.

In a third example, a system is provided. A system for teaching software concepts includes a play device including an area, a plurality of physical objects associated with the play device, and a computing device. The computing device includes one or more processors and a non-transitory computer readable medium having instructions stored thereon that when executed by the one or more processors cause performance of a set of functions. The functions include providing an instruction associated with placing one or more physical objects in the area of the play device. The instruction includes an indication of a source code operator. The functions include determining, based on sensor data from a sensor of the play device, that a physical object of the plurality of physical objects has been placed in the area of the play device. The functions include responsive to determining that the physical object has been placed in the area of the play device, executing an operation corresponding to the source code operator. The functions include determining, by the computing device based on executing the operation, whether the instruction is successfully followed in accordance with the source code operator. The functions include providing an indication of (i) a result of executing the operation corresponding to the source code operator, and (ii) whether the instruction is successfully followed in accordance with the source code operator.

In a fourth example, a method is provided. The method includes providing an instruction associated with placing one or more physical objects in a first area of a play device. The method includes determining, by a computing device, that a physical object has been placed in the first area of the play device. The method includes, responsive to determining that the physical object has been placed in the first area of the play device, encoding the physical object with one or more characteristics of a software object class. The method includes determining, by the computing device, that the object has been placed in a second area of the play device. The method includes, responsive to determining that the physical object has been placed in the second area of the play device, executing, by the computing device, an operation corresponding to the software object class. The method includes providing an indication of a first result of executing the operation corresponding to the software object class.

In a fifth example, a method for teaching software coding concepts is provided. The method includes providing an instruction associated with placing one or more physical objects in a first area of a play device. The method includes determining, by a computing device, that a physical object has been placed in the first area of the play device. The method includes, responsive to determining that the physical object has been placed in the first area of the play device, encoding the physical object with a software function. The method includes determining, by the computing device, that the object has been placed in a second area of the play device. The method includes, after determining that the physical object has been placed in the second area of the play device, executing, by the computing device, an operation corresponding to the software function. The method includes providing an indication of a result of executing the operation corresponding to the software function.

In a sixth example, a method for teaching software coding concepts is provided. The method includes rendering a virtual three-dimensional (3D) environment on a graphical user interface (GUI). The method includes providing on the GUI an instruction indicative of a desired change to the virtual 3D environment. The method includes, based on the desired change, prompting one or more source code inputs on the graphical user interface, wherein the one or more source code inputs interact with the virtual 3D environment. The method includes receiving a source code input. The method includes executing the source code input. The method includes rendering on the GUI a change in the virtual 3D environment that results from executing the source code input, wherein the rendering indicates whether the desired change is achieved.

In a seventh example, a method for teaching language concepts is provided. The method includes providing a first instruction associated with placing one or more play blocks in an area of a play device. The first instruction includes an indication of one or more desired characteristics of the play blocks, and the instruction is provided in a first human language in accordance with a first language mode of the play device. The method includes detecting one or more characteristics of a first play block placed in the area. The method includes determining, based on the one or more characteristics of the first play block, that the first instruction has been successfully followed. The method includes, responsive to determining that the first instruction has been successfully followed, (i) changing from the first language mode of the play device to a second language mode of the play device, and (ii) providing a second instruction associated with placing one or more play blocks in the area. The second instruction includes an indication of one or more second desired characteristics of the play blocks and the instruction is provided in a second human language in accordance with a second language mode.

In an eighth example, a method for teaching language concepts is provided. The method includes providing a first instruction associated with placing one or more play blocks in an area of a play device. The first instruction includes an indication of one or more first desired characteristics of the play blocks, and the instruction is provided in a first human language in accordance with a first language mode of the play device. The method includes detecting, by a computing device, one or more characteristics of a first play block placed in the area. The method includes determining, by the computing device based on the one or more characteristics of the first play block, that the first instruction has been successfully followed. The method includes changing from the first language mode of the play device to a second language mode of the play device. The method includes providing, at a second time, a second instruction associated with placing one or more play blocks in the area, wherein the second instruction includes an indication of one or more second desired characteristics of the play blocks. At least one of the one of the one or more second desired characteristics is different from at least one of the one or more first desired characteristics, and the instruction is provided in a second human language in accordance with a second language mode. The method includes detecting, by the computing device, one or more characteristics of a second play block placed in the area. The method includes determining, by the computing device based on the one or more characteristics of the second play block, that the second instruction has been successfully followed.

In a ninth example embodiment, a system may include various means for carrying out each of the operations of the first, fourth, fifth, sixth, seventh, and/or eighth example embodiment.

The foregoing summary is illustrative only and is not intended to be in any way limiting. In addition to the illustrative aspects, embodiments, and features described above, further aspects, embodiments, and features will become apparent by reference to the Figures and the following detailed description and the accompanying drawings.

### BRIEF DESCRIPTION OF THE DRAWINGS

FIG. 1 is a block diagram of a system, according to an example embodiment.

FIG. 2A is an illustration of a play device, according to an example embodiment.

FIG. 2B is a first simplified sequence of a user interface on the play device, according to an example embodiment.

FIG. 2C is a second simplified sequence of a user interface on the play device, according to an example embodiment.

FIG. 2D is a third simplified sequence of a user interface on the play device, according to an example embodiment.

FIG. 2E is a fourth simplified sequence of a user interface on the play device, according to an example embodiment.

FIG. 2F is a fifth simplified sequence of a user interface on the play device, according to an example embodiment.

FIG. 3 is an illustration of a plurality of play blocks, according to an example embodiment.

FIG. 4 is an illustration of a play block, according to an example embodiment.

FIG. 5 is an illustration of a play block, according to an example embodiment.

FIG. 6 is an illustration of a plurality of sets of play blocks, according to an example embodiment.

FIG. 7 is an illustration of a set of play blocks, according to an example embodiment.

FIG. 8 is an illustration of a play device, according to an example embodiment.

FIG. 9 is an illustration of a play device, according to an example embodiment.

FIG. 10 is an illustration of an input device for a user interface of a play device, according to an example embodiment.

FIG. 11A is an illustration of a virtual environment at a first time, according to an example embodiment.

FIG. 11B is an illustration of a virtual environment at a second time, according to an example embodiment.

FIG. 12 is an illustration of a computing device having an application stored thereon that is configured to interact with a play device, according to an example embodiment.

FIG. 13 is a block diagram of a method, according to an example embodiment.

FIG. 14 is a block diagram of a method, according to an example embodiment.

FIG. 15 is a block diagram of a method, according to an example embodiment.

FIG. 16 is a block diagram of a method, according to an example embodiment.

FIG. 17 is a block diagram of a method, according to an example embodiment.

FIG. 18 is a block diagram of a method, according to an example embodiment.

### DETAILED DESCRIPTION

Example systems, devices, and methods are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Additionally, to the extent that functionality described herein relates to using a given characteristic, parameter, value, or other information to perform an operation, it should be understood that determining and/or obtaining such information is contemplated by the description.

Furthermore, the particular arrangements shown in the Figures should not be viewed as limiting. It should be understood that other embodiments might include more or less of each element shown in a given Figure. Some of the illustrated elements may be combined or omitted. Further, an example embodiment may include elements that are not illustrated in the Figures.

As used herein, the term “source code” refers to text and/or symbols entered into a coding environment and that form one or more commands to be compiled or assembled into executable computer program code. Within examples, source code is referred to as being “executed,” and this may refer to computer program code representing the source code being executed

As used herein, the term “source code operator” refers to a symbol or arrangement of alphanumeric characters that serve as an identifier for some functionality in source code. The identifier is disposed between two or more inputs or operands in a line of source code and thereby defines a relationship between the inputs or operands. For example, the source code operator can be a logical operator, a comparative operator, a mathematical operator, or another type of operator.

### I. OVERVIEW

Example embodiments include or otherwise relate to systems and methods for teaching software coding concepts. In the field of education technology, and particularly education technology related to teaching software concepts, some existing systems and methods rely on conventional computing devices that use input prompts in an attempt to convey a concept. In an educational setting, particularly in an educational setting aimed at children, this framework may fail to teach software concepts in an intuitive manner. In particular, younger children (e.g., children aged 2-8), may struggle to competently or safely interact with user interfaces (e.g., touchscreens) of a conventional computing device, and for this reason may lack an opportunity to acquire coding skills until reaching an older age. Additionally, conventional software education devices may lack user engagement due to providing superficial rewards for learning new concepts. Still further, software education applications on a mobile device, tablet, or personal computer may increase undesirable screen time for children.

Examples described herein include a play device that is configured to teach software concepts in an intuitive manner that leverages source code operators. For example, the play device may provide instructions to find a play block or another physical object that satisfies a first characteristic OR (∥) a second characteristic, or to find a play block that satisfies the first characteristic AND (&&) a third characteristic, or to find a play block that does NOT (!) satisfy a fourth characteristic. The play device can detect which play block is selected by the user, and determine whether the instruction has been correctly followed. By encouraging a user to find inputs that satisfy an instruction in accordance with each source code operator, and by using play blocks that have readily understandable characteristics (such as a shape, color, number, letter, or picture of an object), the user can gradually understand how each operator works. This understanding can be tied to fundamental concepts of other subjects, such as language and mathematics.

Example play devices emphasize the concept of object-oriented programming by treating play blocks or other physical objects as objects in a software object class. For example, a sensor may detect an identifier of the play block, and the play device may create a software representation of the play block based on the identifier and evaluate the software representation of the play block based on an instruction. The representation is a “block” object in a class containing a plurality of characteristics (e.g., shape and color). In this manner, placing the play block in an area of the play device amounts to entering an object input into a function in a software program. The play device can execute an operation using the input and compare a result of executing the operation to an expected result to determine whether the instruction has been correctly followed. In this manner, a user can observe and physically interact with an input to a software operation, and thus may better understand the result of the software operation.

Example play devices operate in a plurality of different modes that each focus on different source code operators. For example, a first mode may include incremental or decremental operators and may focus on counting play blocks, a second mode may include logical operators and/or comparative operators and may focus on finding play blocks with particular characteristics, and a third mode may include a combination of these operators and may focus on correctly determining a Boolean output. These different modes may allow for a user to focus on particular aspects of software coding, perhaps to emphasize a type of operator that the user is struggling to understand.

Example play devices keep track of user performance and output a score for the user that indicates accumulated points. These points can be used to show progress, but also can be used to unlock new lessons. Within examples, a block dispenser can include new play blocks that the user has not yet used on the play device, and the play device can cause the block dispenser to dispense a play block in response to correctly following an instruction in accordance with a source code operator and having a threshold number of points. This can engage the user by providing a reward for consistent effort while also providing another play block that allows for more difficult instructions from the play device.

Example play devices can interact with another computing device (e.g., a mobile device) having an application stored thereon that is used for configuring one or more aspects of the play device. For example, the application can be used to track user performance, but also can be used to spend points on lessons, play blocks, or new functionality of the play device. For example, the application can be used to select a math module to install on the play device, or can be used to select new blocks to be shipped to an address associated with the play device. In this manner, a user can gradually increase functionality of the play device.

Example play devices may leverage a fundamental understanding of software concepts to teach language skills to the user. For example, a play block may include a representation of a word that is known to the user (e.g., the color blue) and may include a representation (e.g., a picture) of a word that is unknown to the user (e.g., “giraffe”). The play device may prompt the user for a block that shows the color “red” OR an “animal,” and the user may guess that the “giraffe block” shows an animal or select the block at random. When the play device indicates that the selected block correctly followed the prompt, the user can infer that giraffes are animals, because the user knows that the block is not red. Later, the play device may prompt for a “giraffe,” and the user can thus get a more specific understanding of the word. This same framework can be applied to teach words in multiple languages, perhaps using the source code operator as a common theme across multiple human languages, and simplifying how words in a new language are conveyed to the user.

Using play blocks or other physical objects as inputs for a play device may avoid an undesirable amount of screen time for children, and also engages motor skills by prompting a user to move play blocks. Leveraging the connection between motor skills and memory to teach software coding concepts may allow children to learn these concepts more quickly. In addition, this manner of teaching may be more accessible to a wide array of children than using a conventional computing device. For example, play devices that use braille play blocks may by useful for blind children, and play devices that provide animations of the instructions and received inputs may be useful for deaf children.

Accordingly, the systems and methods described herein provide play devices configured to overcome issues that are present in education technology by using physical objects to serve as inputs for software coding prompts, mathematical prompts, language prompts, or prompts related to other subjects, thereby providing an intuitive way of learning new concepts. This framework similarly can be approachable for younger children who lack fine motor skills needed to control a conventional computing device, but who can pick up and move physical objects such as play blocks. Additionally, systems and methods are described that allow for increased and sustained user engagement by dispensing new objects (e.g., play blocks) for the user to use as a reward for learning new concepts. Still further, systems and methods described herein that encourage learning progression by providing increasingly difficult tasks for users as new concepts are learned and new objects are dispensed for the user to use. These and other benefits for and improvements to education technology, and software coding education technology in particular, will be apparent to those having skill in the art.

These and other examples are described below with respect to the drawings. Though the description provided herein describes several examples of teaching software coding concepts in conjunction with mathematics or language concepts, the following description contemplates play devices and play blocks that are similarly configured to those for teaching coding, but that can instead be used specifically for teaching mathematics or language concepts. In alternative examples, a play device can switch between a coding mode, a math mode, a language mode, and perhaps other modes associated with teaching additional subjects.

### II. EXAMPLE SYSTEMS AND DEVICES

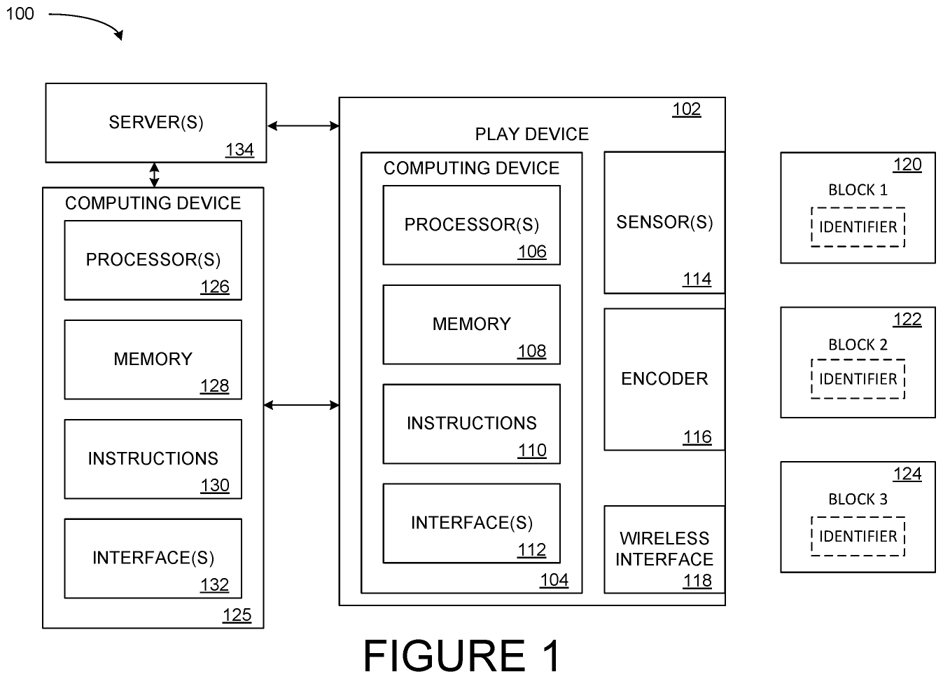

FIG. 1 is a block diagram of a system, according to an example embodiment. In particular, FIG. 1 shows a system 100 that includes a play device 102. The play device 102 includes a computing device 104, one or more sensors 114, an encoder 116, and a wireless interface 118. The computing device 104 includes one or more processors 106, a memory 108, instructions 110, and one or more interfaces 112.

The one or more processors 106 operate as one or more general-purpose hardware processors or special purpose hardware processors (e.g., digital signal processors, application specific integrated circuits, etc.), and may be configured to execute computer-readable program instructions (e.g., instructions 110), and manipulate data, both of which may be stored in the memory 108. The one or more processors 106 may also directly or indirectly interact with other components of the system 100. The one or more processors 106 may include, for instance, a microprocessor, an application-specific integrated circuit (ASIC), or a field-programmable gate array (FPGA). Other types of processors, computers, or devices configured to carry out software instructions are contemplated herein.

The memory 108 may be one or more types of hardware memory, and can include a computer readable medium, such as a non-transitory computer readable medium. For example, the memory 108 may include or take the form of one or more computer-readable storage media that can be read or accessed by processor(s) 106. The computer readable medium can include volatile or non-volatile storage components, such as optical, magnetic, organic, or another type of memory or storage, which can be integrated in whole or in part with processor(s) 106. In some implementations, the memory 108 can be a single physical device. In other implementations, the memory 108 can be implemented using two or more physical devices, which may communicate with one another via wired or wireless communication. The memory 108 may include read-only memory (ROM), programmable read-only memory (PROM), erasable programmable read-only memory (EPROM), electrically erasable programmable read-only memory (EEPROM), non-volatile random-access memory (e.g., flash memory), a solid state drive (SSD), a hard disk drive (HDD), a Compact Disc (CD), a Digital Video Disk (DVD), a digital tape, read/write (R/W) CDs, R/W DVDs, etc. Other types of computer readable media are contemplated herein. As noted previously, the memory 108 may include the instructions 110 and data. The data be any type of data, such as configuration data, sensor data, or diagnostic data, among other possibilities. For example, the data may include records of one or more physical objects associated with the play device 102.

The instructions 110 may include source code or computer readable code configured to be executed by one or more processors. As described in greater detail below, the instructions 110 may be executed by the processor(s) 106 to control aspects of the play device 102, and to communicate with one or more other computing devices, servers, or databases.

The one or more user interfaces 112 may include or take the form of a keyboard, a mouse, a digital display, a screen (e.g. a touchscreen), a microphone, a speaker, a gesture recognition system, a combination thereof, or another visual or audio interface used for conveying information to and/or receiving input from a user of the computing device 104. The one or more user interfaces 112 can be integrated into the computing device 104 as depicted in FIG. 1 or be included in another subsystem or device.

The play device 102 further includes one or more sensors 114. The one or more sensors 114 may include any sensors configured to determine that a physical object is present in an area of the play device 102. For example, the one or more sensors 114 can include one or more of a Radio-Frequency Identification (RFID) sensor, a proximity sensor, an image capture device, a bar code scanner, or another device configured for detecting a physical object. The one or more sensors 114 are used for providing senor data associated with detecting that a play block has been placed in an area of the play device 102, and can detect characteristics of the play block. For example, the characteristics can be determined based on an identifier on the play block.

The play device further includes an encoder 116. The encoder 116 may be an RFID encoder, or another type of encoder. The encoder 116 may be used to store information contained on the computing device 104 on a play block. For example, the encoder 116 can be used to store one or more characteristics of a software object class on the play block or store a software function on the play block after the play block has been placed in the area of the play device 102. Within examples, the play device may include a plurality of encoders.

The play device 102 further includes a wireless interface 118 (e.g., an antenna). The wireless interface 118 may be configured for wireless communication with one or more computing devices, either directly or over a network. For example, the wireless interface 118, in conjunction with the computing device 104 or a dedicated communications module of the play device 102, may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Within examples, the play device 102 may additionally or alternatively include wireline interfaces such as an Ethernet interface, a Universal Serial Bus (USB) interface, or similar interfaces for communicating via a wire, a twisted pair of wires, a coaxial cable, an optical link, a fiber-optic link, or other physical connection to a wireline network. Other wireless or wireline interfaces are possible.

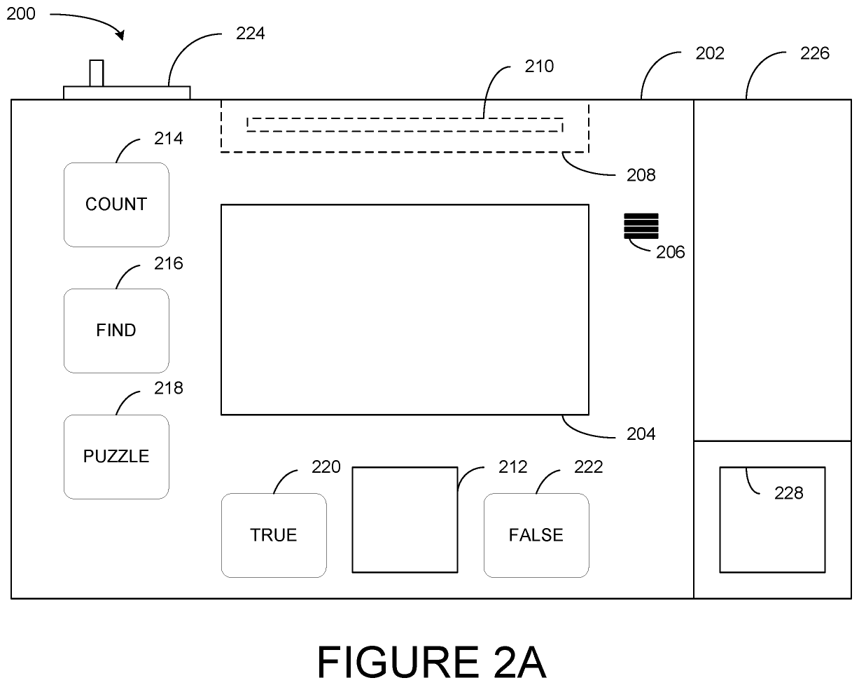

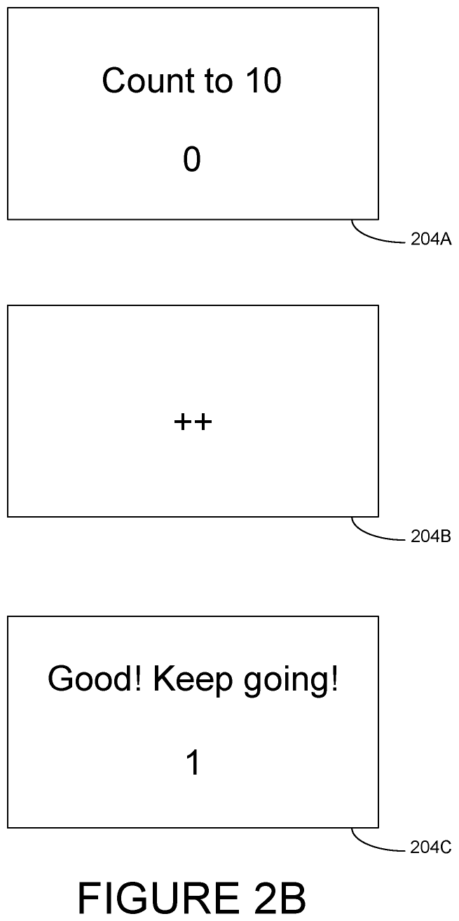

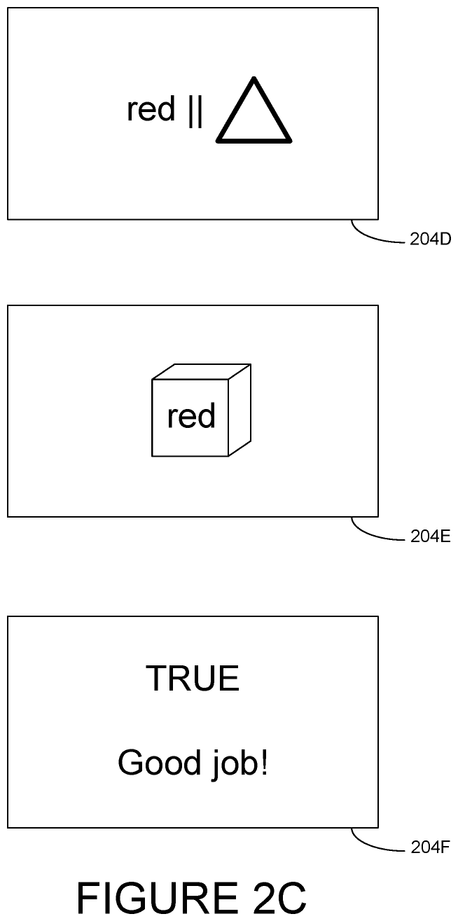

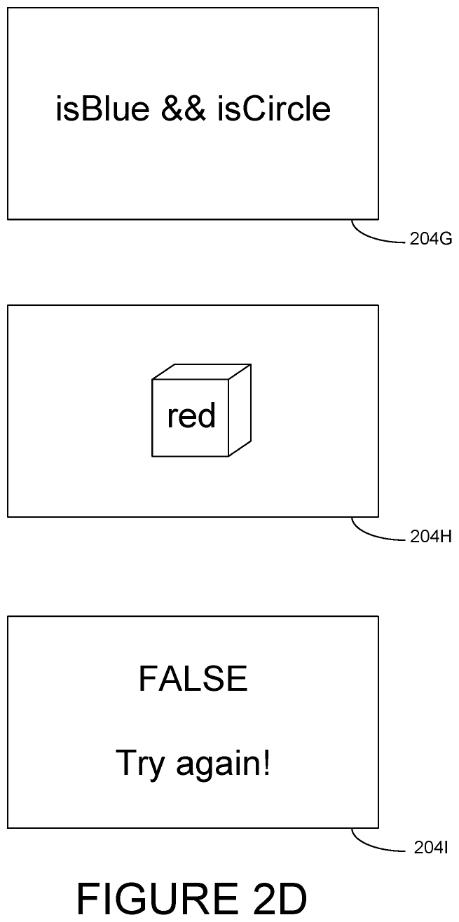

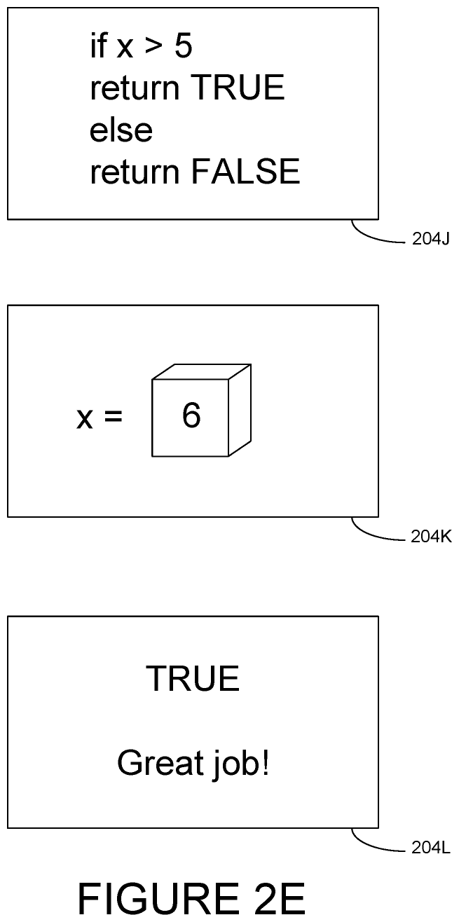

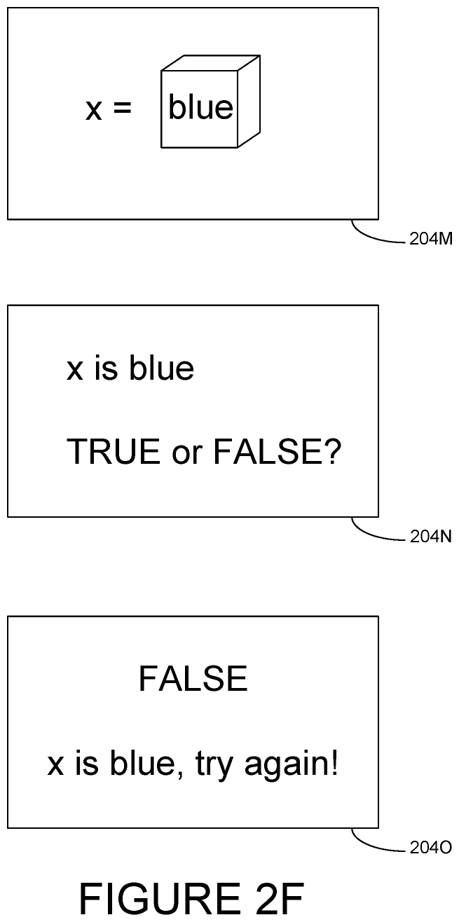

The system 100 further includes a plurality of play blocks that include a first block 120, a second block 122, and a third block 124. The first block 120, second block 122, and third block 124 each include an identifier that contains information about the block. For example, the identifier may show a size or shape of the block, a picture displayed on the block, or one or more categories of the block. The plurality of the blocks can be placed in an area of the play device 102. Within the area, the one or more sensors 114 or the encoder can interact with each block. The one or more sensors 114 can detect information from the identifier. The encoder 116 can alter or add to the information contained on the identifier. The information associated with each block can be evaluated to determine whether a particular instruction from the one or more interfaces 112 of the play device 102 (e.g., displayed on a GUI and/or projected from a speaker) is correctly followed using the block. The computing device 104 can cause the interface(s) 112 to indicate whether the instruction is followed. More details regarding this process are described in further detail with respect to FIGS. 2A-18.

The system 100 further includes a computing device 125. The computing device 125 includes one or more processors 126, a memory 128, instructions 130, and one or more interfaces 132. The one or more processors are configured similarly to the one or more processors 106. The memory 128 is configured similarly to the memory 108. The instructions 130 are configured similarly to the instructions 110 and can be executed by the one or more processors 126 to perform functions of the computing device 125. The one or more interfaces 132 can be configured similarly to the one or more interfaces 112.

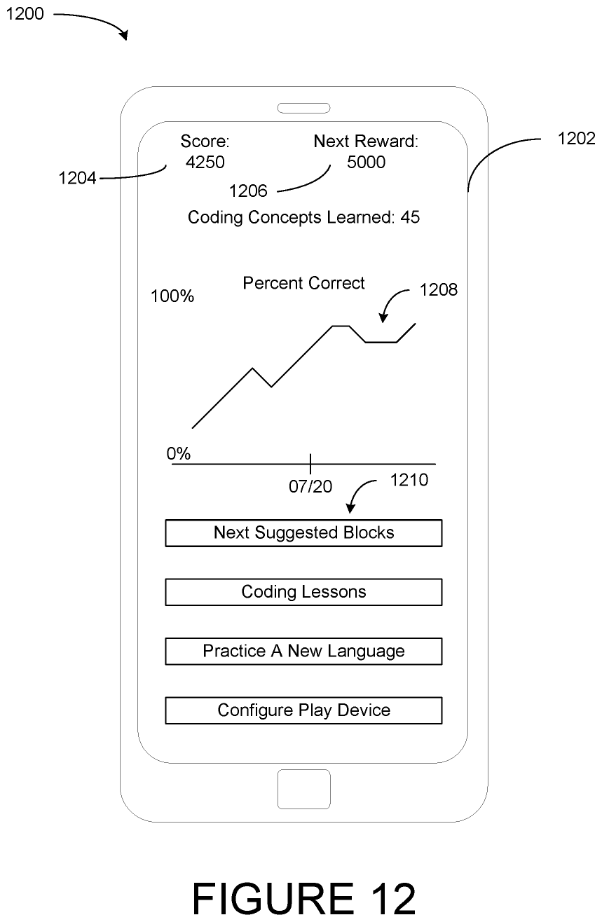

The computing device 104 may be referred to as a “first computing device” and the computing device 125 may be referred to as a “second computing device.” Referring to the computing devices in this manner does not necessarily imply primacy of the computing device 104, and embodiments described herein may be partially or completely be performed by the computing device 125. The computing device 125 may be remote from the play device 102, and can be configured to interact with the play device to display aspects of a user interaction with the play device 102, to track a user's progress in one or more educational lessons while using the play device 102, or to configure aspects of the play device 102, such as causing the play device 102 to begin a new operation mode or to install a new functionality. Further details regarding these interactions are described bellowed with respect to FIG. 12.

The system 100 further includes one or more servers 134. The one or more servers 134 include at least one computing device and/or database, and are configured to coordinate aspects of a plurality of play devices. For example, the one or more servers 134 can be used to track progress of a plurality of users of a plurality of play devices and to store user profiles for the plurality of users.

The one or more servers 134 communicate with the play device 102 and the computing device 125, thereby facilitating certain interactions between the computing device 125 and the play device 102. For example, the computing device 125 may have a software application stored thereon that is used for configuring one or more aspects of the play device 102, and the one or more servers 134 may facilitate the configurations. For example, these configurable aspects may include a current user profile of the play device 102, a difficulty level of the play device 102, a language mode of the play device 102, or a new teachable subject (e.g., a math subject or a human language subject) of the play device 102. The one or more servers 134 can also be used to track progress of a user of the play device 102 relative to other users. The one or more servers 134 may interact with the computing device 125 and the play device 102 in other ways as well.

The system 100 includes a play device 102 having an area, a plurality of physical objects associated with the play device 102, and a computing device. The computing device includes one or more processors and a non-transitory computer readable medium having instructions stored thereon that when executed by the one or more processors cause performance of a set of functions, the functions. The functions include providing an instruction associated with placing one or more physical objects (e.g., the first block 120, the second block 122, and/or the third block 124) in the area of the play device 102. For example, the instruction can be provided by the one or more interfaces 112. The instruction includes an indication of a source code operator (e.g., ∥, &&, or !). The functions further include determining, based on sensor data from a sensor 114 of the play device 102, that a physical object of the plurality of physical objects has been placed in the area of the play device. The functions further include, responsive to determining that the physical object has been placed in the area of the play device 102, executing an operation corresponding to the source code operator. The functions further include determining, by the computing device based on executing the operation, whether the instruction is successfully followed in accordance with the source code operator. The functions further include providing an indication of (i) a result of executing the operation corresponding to the source code operator, and (ii) whether the instruction is successfully followed in accordance with the source code operator. For example, the indications can be provided by the one or more interfaces 112.

Within examples, the computing device is a first computing device (e.g., the computing device 104) included within the play device 102, and the functions further include controlling the play device based on control instructions received from a second computing device (e.g., the computing device 125).

Further details regarding functions of the play device 102 and corresponding systems are provided below with respect to FIGS. 2A-18.

FIG. 2A is an illustration of a play device, according to an example embodiment. In particular, FIG. 2A shows a play device 200. The play device 200 includes a housing 202, a visual interface 204 (e.g., a GUI on a screen) in the housing 202, and an audio interface 206 (e.g., a speaker) disposed in the housing 202. The visual interface 204 and/or the audio interface 206 may be used to provide an instruction for a user to perform a task involving one or more physical objects. For example, the instruction may direct the user to place a physical object in an area 208 of the play device 200. In FIG. 2A, the area 208 is an opening in a top portion of the housing 202 that allows a physical object, such as a play block, to be placed therein. In other examples, the area 208 may be located in another portion of the housing 202, or may be separate from the housing 202. Though example physical objects described herein are depicted and described as play blocks, other types of objects, such as tokens, coins, balls, cartridges, cards, or other objects are possible. Generally, the physical objects described herein can be understood as being similarly configured to one another, with notable differences in one or more characteristics, such as shape or color, or displaying different words, symbols, or images on respective surfaces of the objects.

The play device 200 further includes a sensor 210 configured to detect that the physical object has been placed in the area 208, and which may detect one or more characteristics of the physical object. For example, the sensor 210 may include an RFID reader configured to read an identifier stored on an RFID of a physical object. In other examples, the sensor 210 may include a bar code scanner or a QR code scanner configured to read an identifier stored on a bar code or QR code printed on an outer surface of the physical object. Reading the identifier may indicate that the physical object has been placed in the area 208 and may allow the play device 200 or a computing device associated with the play device 200 to detect one or more characteristics indicated by the identifier. Other types of sensors can be included in the play device 200. The sensor 210 provides sensor data interpreted by a computing device to determine that a physical object has been placed in the area 208. For example, the sensor data may replicate the identifier, one or more characteristics extracted from the identifier, or signal that an object has been detected by the sensor 210.

The play device 200 further includes an exit 212 for a physical object placed in the area 208. In FIG. 2A the exit 212 is disposed in a front portion of the housing 202. In other examples, the exit 212 can be placed in another portion of the housing 202. For example, the exit 212 may be placed in a side portion of the housing and may deposit each physical object placed in the area 208 into a collection receptacle (not illustrated).

The play device 200 may operate in a plurality of play modes, and have corresponding play mode buttons. In the example illustrated by FIG. 2A, the play mode buttons include a first button 214 corresponding to a count mode, a second button 216 corresponding to a find mode, and a third button 218 corresponding to a puzzle mode. Pressing one of the buttons causes the play device 200 to change the play mode. The play device or a computing device thereof can also automatically change play modes, perhaps based on learning goals for the user or based on a targeted concept for the user based on the user's learning performance (e.g., based on a percentage of correct answers corresponding to a particular source code operator being below a threshold percentage). Further details regarding the count mode, the find mode, and the puzzle mode are provided below with respect to FIGS. 2B-2F. Each of these play modes may correspond to one or more source code operators, and may incorporate mathematics and/or language concepts as well. Other play modes are possible that might not correspond to software coding concepts. For example, the play device 200 may be configured to additionally or alternatively to operate to teach mathematics concepts or human language concepts. In these examples, the buttons can be reconfigured based on operation of the play device (e.g., the buttons may include screens or digital displays that change depending on the operation of the play device 200).

The play device 200 further includes a first input button 220 and a second input button 222. The first input button 220 includes a Boolean “TRUE” input and the second input button 222 includes a Boolean “FALSE” input. For example, the TRUE and FALSE inputs can be used in one or more play modes of the play device 200, as described further below with respect to FIG. 2F.

The play device 200 further includes a switch 224. For example, the switch 224 can correspond to changing a difficulty level of the play device 200. The difficulty levels may gradually change the amount or type of information provided to the user, allowing the user to learn increasingly complex lessons.

The play device 200 further includes an object dispenser 226 (otherwise referred to herein as a “block dispenser”). The object dispenser 226 includes one or more new physical objects for the user that can be dispensed via a new object exit 228 when one or more benchmarks are achieved. For example, the play device may increase a score for a user after the user successfully follows an instruction, and the object dispenser 226 may dispense a new block when a threshold score is achieved. New blocks may include characteristics that have not previously been introduced to the user, and thus may allow the play device to increase complexity of the instructions. For example, the new blocks may correspond to a new category of words that can be included in instructions, such as numbers, letters, animals, household items, or other categories of words that can be used in instructions of the play device 200. By dispensing new objects in response to learning progress of the user, the play device 200 may reward the user for sustained use and encourage further engagement.

Within examples, the play device 200, or a computing device associated with the play device 200, may store a list of physical objects available to the play device based on detections by the sensor 210. The list includes one or more characteristics of each physical object. In these examples, the play device 200 may determine one or more instructions based on the list of physical objects available to the play device. For example, as objects are used after being dispensed by the object dispenser 226, a computing device can track their subsequent use by using the sensor 210 (or a sensor of the object dispenser 226), and can thereby expand the instructions provided to the user. For example, if the object dispenser 226 dispenses physical objects with pictures of animals, the play device 200 can track the use of an “animal” object and thereafter add instructions involving an animal characteristic (e.g., “Find a red block OR a block with a picture of an animal.”).

Reference is now made to FIGS. 2B-2F, which each depict examples of sequences of an interface provided to the user. These are provided for illustrative purposes, and other sequences of the interface can be provided to the user in practice.

FIG. 2B is a first simplified sequence of an interface on the play device 200, according to an example embodiment. In particular, FIG. 2B shows the play device 200 operating in a count mode and providing different illustrations and/or animations on the visual interface 204 at a first time 204A, a second time 204B, and a third time 204C.

At the first time 204A, the user interface shows an instruction to count to 10, along with a number 0 to indicate a starting point for counting. The instruction corresponds to placing one or more physical objects into the area 208 of the play device 200. For example, the audio interface 206 may indicate that the user should “count up to 10 using your blocks.”

In alternative examples, such as at a higher difficulty level of the play device 200, the starting point could be at a different number. For example the instruction might be to count from 5 to 11. In other examples, counting could include counting down from one number to another, or counting by twos or threes. In additional examples, the user may be instructed to count using particular types of objects, such as play blocks that are colored blue, or play blocks that show an animal. Other examples of counting instructions are possible.

As discussed further below, the instruction is provided in accordance with a source code operator. In particular, an incremental operator is used to update an output number as the user places physical objects in the area 208 of the play device 200. In some examples, the instruction may include a visual indication of the source code operator (e.g., a ++ source code operator), or an audio indication of the source code operator.

At the second time 204B, the user interface shows an indication of a ++ source code operator. This operator serves to increment an input number by 1. The play device may provide the indication of ++ source code operator responsive to detecting that a physical object has been placed in the area 208 of the play device 200. For example, the play device 200 may determine this based on sensor data from the sensor 210. In this manner, the play device 200 displays a connection between the source code operator and placing the physical object in the area 208.

Responsive to determining that the physical object has been placed in the area 208 of the play device 200, the play device 200 or a computing device thereof can execute an operation corresponding to the source code operator. For example, this may involve iterating through a single step of a for loop that iterates an input each time an object is placed in the area 208 of the play device 200.

At the third time 204C, the user interface shows, based on executing the operation, whether the instruction is successfully followed in accordance with the source code operator. In the present example, the user is instructed to place a physical object in the area 208 to count to 10, so each placed object partially completes the instruction until 10 blocks have been used to complete the task set out by the instruction. The user interface further provides an indication of (i) a result of executing the operation corresponding to the ++ source code operator (showing that the input is now 1 instead of 0, and (ii) whether the instruction is successfully followed in accordance with the source code operator (showing the output “Good! Keep going!” on the visual interface 204).

As noted above, this process may continue until the user has placed ten physical objects in the area 208 in accordance with the instruction and the ++ operator. Other incremental operators, such as −−, +=, and −= operators can be used in other examples. In addition, other instructions and indications of progress towards completing the instruction are possible. For example, source code of a for loop including the incremental operator can be used to show the user how a for loop operates. In these examples, placing the physical object in the area 208 of the play device 200 may serve a similar purpose to debugging a software program. For example, a break in the source code can be placed within the for loop, and detecting that the physical object has been placed in the area 208 can cause the source code to run until hitting another break in another iteration of the for loop. This process can be animated, perhaps with accompanying audio outputs, to demonstrate how the for loop operates.

In a count mode of the play device 200, varying the type of incremental operator, the manner of displaying the instruction, the operation corresponding to the source code operator, and the result of executing the operation each can assist in gradually teaching concepts related to incremental source code operators to the user. Further, as the difficulty level increases and more detailed instructions are provided to the user, other software concepts such as for loops, while loops, or the like can be conveyed to the user. Still further, mathematical concepts such as counting, adding, subtracting, multiplying, dividing, or the like can be conveyed to the user. Still further, language can be conveyed to the user, such as by making the instruction conditional on a certain type of object (e.g., blue blocks, or triangle blocks) being used for counting.

FIG. 2C is a second simplified sequence of a user interface on the play device, according to an example embodiment. In particular, FIG. 2C shows the play device 200 operating in a find mode and providing different illustrations and/or animations on the visual interface 204 at a first time 204D, a second time 204E, and a third time 204F.

At the first time 204D, the user interface shows an instruction to find a physical object that is red OR that has a triangle shape. The instruction corresponds to placing one or more physical objects into the area 208 of the play device 200 in accordance with a logical ∥ operator. For example, the audio interface 206 may indicate that the user should “find a block that is red OR shaped like a triangle.”

In alternative examples, such as at a higher difficulty level of the play device 200, more than one logical operator (e.g, a ! operator or an && operator) can be used in the instruction, or logical operators can be used in conjunction with other types of operators, such as comparative operators (e.g., <, >, ==, <=, or >=). Other examples of instructions to find certain physical objects are possible.

At the second time 204E, the user interface shows an indication of an object that was placed in the area 208 of the play device. In particular, an illustration and/or animation of a red, square play block is shown. The sensor 210 can determine characteristics of the physical object, and a computing device can use these characteristics to create a representation of the physical object selected by the user.

Responsive to determining that the physical object has been placed in the area 208 of the play device 200, the play device 200 or a computing device thereof can execute an operation corresponding to the source code operator. For example, this may involve executing a logical function that compares one or more characteristics of the physical object to the characteristics of the instruction in accordance with the logical ∥ operator.

At the third time 204F, the user interface shows, based on executing the operation, whether the instruction is successfully followed in accordance with the source code operator. In the present example, the user is instructed to place a physical object having one or more particular characteristics in the area 208. The user interface further provides an indication of (i) a result of executing the operation corresponding to the logical ∥ operator (showing that the input results in a Boolean TRUE output), and (ii) whether the instruction is successfully followed in accordance with the source code operator (showing the output “Good job!” on the visual interface 204).

Other logical or comparative operators can be used in other examples. In addition, other instructions and indications of progress towards completing the instruction are possible. For example, source code of an if statement, an if else statement, or a ternary operator can be used to show the user how these logical functions operate. In these examples, placing the physical object in the area 208 of the play device 200 may serve a similar purpose to debugging a software program. For example, a visual animation of the source code operator and one or more desired characteristics can show whether any characteristics of the physical object match a desired characteristic in accordance with the source code operator.

In a find mode of the play device 200, varying the type of operator, the manner of displaying the instruction, the operation corresponding to the source code operator, and the result of executing the operation each can assist in gradually teaching concepts related to logical or comparative source code operators to the user. Further, as the difficulty level increases and more detail is provided, other software concepts such as if statements, if else statement, ternary operators, or the like can be conveyed to the user. Still further, mathematical concepts such as greater than, less than, equal to, or the like can be conveyed to the user. Still further, language can be conveyed to the user, such as by making the instruction conditional on a certain type of object (e.g., blue blocks, or triangle blocks) being used in the instruction.

FIG. 2D is a third simplified sequence of a user interface on the play device, according to an example embodiment. In particular, FIG. 2D shows the play device 200 operating in a find mode and providing different illustrations and/or animations on the visual interface 204 at a first time 204G, a second time 204H, and a third time 204I. FIG. 2D shows a different implementation of a find mode of the play device 200 in which pseudo-code is provided in the instruction, as described further below.

At the first time 204G, the user interface shows an instruction to find a physical object that is blue AND that has a circle shape. The instruction corresponds to placing one or more physical objects into the area 208 of the play device 200 in accordance with a logical && operator. For example, the audio interface 206 may indicate that the user should “find a block that is blue AND shaped like a circle.” With this audio instruction, the play device 200 provides a visual illustration and/or animation of pseudo-code relating to the desired characteristics of the physical object.

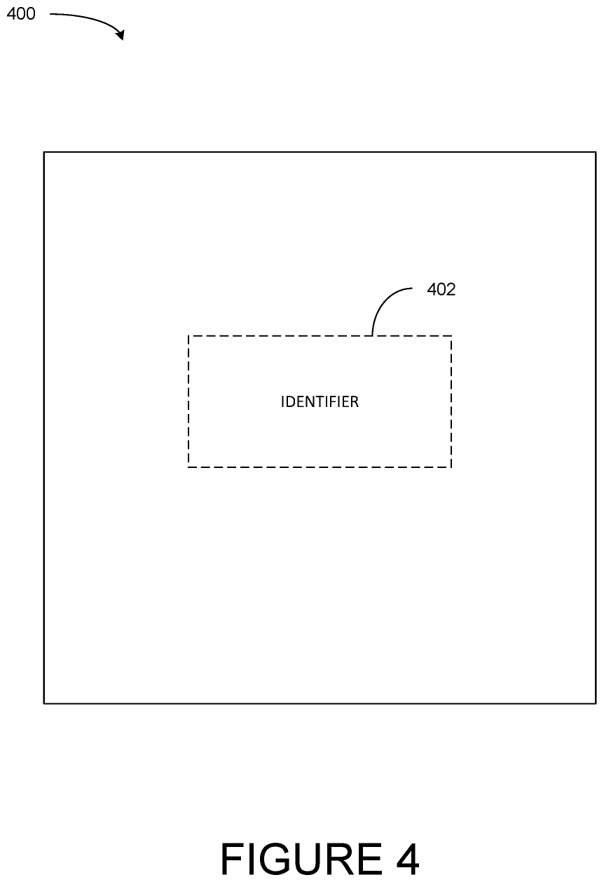

In FIG. 2D, the pseudo-code is “isBlue && isCircle” and may correspond to an increased difficulty level relative to the example depicted in FIG. 4C. In other examples, actual source code can be provided in the instruction using C++, Java, Python, or other coding languages. In some examples, the coding language can be toggled by a user, or can be automatically changed by the play device.

At the second time 204H, the user interface shows an indication of an object that was placed in the area 208 of the play device. In particular, an illustration and/or animation of a red, square play block is shown. The sensor 210 can determine characteristics of the physical object, and a computing device can use these characteristics to create a representation of the physical object selected by the user.

Responsive to determining that the physical object has been placed in the area 208 of the play device 200, the play device 200 or a computing device thereof can execute an operation corresponding to the source code operator. For example, this may involve executing a logical function that compares one or more characteristics of the physical object to the characteristics of the instruction in accordance with the logical && operator.

At the third time 204I, the user interface shows, based on executing the operation, whether the instruction is successfully followed in accordance with the source code operator. In the present example, the user is instructed to place a physical object having one or more particular characteristics in the area 208. The user interface further provides an indication of (i) a result of executing the operation corresponding to the logical && operator (showing that the input results in a Boolean FALSE output), and (ii) whether the instruction is successfully followed in accordance with the source code operator (showing the output “Try again!” on the visual interface 204).

FIG. 2E is a fourth simplified sequence of a user interface on the play device, according to an example embodiment. In particular, FIG. 2E shows the play device 200 operating in a find mode and providing different illustrations and/or animations on the visual interface 204 at a first time 204I, a second time 204K, and a third time 204L. FIG. 2E shows a different implementation of a find mode of the play device 200 in which source code is provided in the instruction, as described further below.

At the first time 204I, the user interface shows an instruction to find a physical object that has a number greater than 5 (e.g., a play block with a picture of a number on it). The instruction corresponds to placing one or more physical objects into the area 208 of the play device 200 in accordance with a comparative > operator. For example, the audio interface 206 may indicate that the user should “find a number block that is greater than 5.” With this audio instruction, the play device 200 provides a visual illustration and/or animation of source code relating to the desired characteristics of the physical object.

In FIG. 4E, the pseudo-code is an if else statement (without additional syntax), and may correspond to an increased difficulty level relative to the examples depicted in FIG. 4C and FIG. 4D. In some examples, a coding language associated with the source code can be toggled by a user, or can be automatically changed by the play device in order to teach specific syntax for different coding operations, such as if statements, if else statements, for loops, while loops, etc.

At the second time 204K, the user interface shows an indication of an object that was placed in the area 208 of the play device. In particular, an illustration and/or animation of a play block with the number 6 is shown. The sensor 210 can determine characteristics of the physical object, and a computing device can use these characteristics to output a representation of the physical object to represent the input. A variable x is also shown to convey that the block is acting as an input to the source code provided at the first time 204J. This can assist in teaching the concept of variables to the user by showing that the x variable takes on the value of the object placed in the area 208 of the play device 200.

Responsive to determining that the physical object has been placed in the area 208 of the play device 200, the play device 200 or a computing device thereof can execute an operation corresponding to the source code operator. For example, this may involve executing a comparative function that compares one or more characteristics of the physical object to the characteristics of the instruction in accordance with the comparative > operator.

At the third time 204L, the user interface shows, based on executing the operation, whether the instruction is successfully followed in accordance with the source code operator. The user interface further provides an indication of (i) a result of executing the operation corresponding to the comparative > operator (showing that the input results in a Boolean TRUE output), and (ii) whether the instruction is successfully followed in accordance with the source code operator (showing the output “Great job!” on the visual interface 204).

Though not depicted in FIG. 2E, the user interface may also show a relevant line of source code from the instruction in response to detecting that the physical object has been placed in the area 208. For example, because x=6, the “if x>5” and “return TRUE” lines can be sequentially highlighted from the instruction to show how the computing device of the play device 200 is executing the operation. This can convey to the user that source code is executed line by line.

FIG. 2F is a fifth simplified sequence of a user interface on the play device, according to an example embodiment. In particular, FIG. 2F shows the play device 200 operating in a puzzle mode and providing different illustrations and/or animations on the visual interface 204 at a first time 204M, a second time 204N, and a third time 2040.

At the first time 204M, the user interface shows an indication of an object that was placed in the area 208 of the play device. For example, the object may be a most recent object placed in the area 208. In particular, an illustration and/or animation of an x variable being equal to a blue, square play block is shown. The sensor 210 can determine characteristics of the physical object, and a computing device can use these characteristics to output a representation of the physical object to represent the input. This illustration and/or animation may be displayed at the same time that an audio instruction is provided to remember the value of the x variable.

At the second time 204N, the user interface shows a Boolean prompt. In particular, an illustration and/or animation of a Boolean statement “x is blue,” with a prompt to select whether the Boolean statement results in a TRUE or FALSE based on the value of the x variable.

Responsive to determining that the physical object has been placed in the area 208 of the play device 200, the play device 200 or a computing device thereof can execute an operation corresponding to the source code operator. For example, this may involve executing a logical function that compares one or more characteristics of the x variable to the characteristics of the Boolean statement. Further, a selection by the user can be compared to this function. In the present example, the user should select TRUE to correctly follow the instruction.

At the third time 2040, the user interface shows, based on executing the operation, whether the instruction is successfully followed in accordance with the source code operator. In the present example, the instruction relates to correctly selecting a Boolean output of executing an operation using one or more characteristics from the physical object, and the user has incorrectly selected FALSE. The user interface further provides an indication of (i) a result of executing the operation (showing that the “x is blue” and implying that the result is TRUE), and (ii) whether the instruction is successfully followed in accordance with the source code operator (showing the output “try again!” on the visual interface 204).

The puzzle mode of the play device 200 allows for the user to test his or her understanding of software coding concepts by correctly interpreting a Boolean statement. The inputs used to test this understanding may include one or more buttons on the play device 200, or a type of physical object (e.g., an operator block) that is placed in the area 208 of the play device.

Within examples, the play device is configured to automatically generate instructions similar to those depicted in FIGS. 2B-2F based on (i) a play mode of the play device, (ii) a set or characteristics for physical objects available to the play device (e.g., based on a list of physical objects maintained by the play device), and (iii) a difficulty level for the play device. The instructions can be pseudo-randomly generated using sets of available source code operators and desired characteristics. The difficulty level can be determined automatically as a user progresses through multiple instructions. For example, if the user has successfully followed a threshold percentage (e.g., 80%) of instructions within a given timeframe (e.g., a week) or within a given number of instructions (e.g., within the most recent 100 instructions), the play device may automatically increase the difficulty level. As the difficulty level increases, the instructions may provide less information to the user. For example, at a first difficulty level, an animation depicting aspects of the instruction (e.g., an animation of a play block having one or more desired characteristics) is provided, at a second difficulty level, pseudo-code for the instruction is provided, and at a third difficulty level, source code is provided. As another example, at a first difficulty level, an desired color can be displayed for the user, at a second difficulty level, the desired color is not displayed for the user, and at a third difficulty level, the a false color is displayed for the user while another color is requested in the instruction. This progression allows the user to reinforce conceptual ideas (such as logical, comparative, mathematical, or language concepts) while also learning coding concepts.

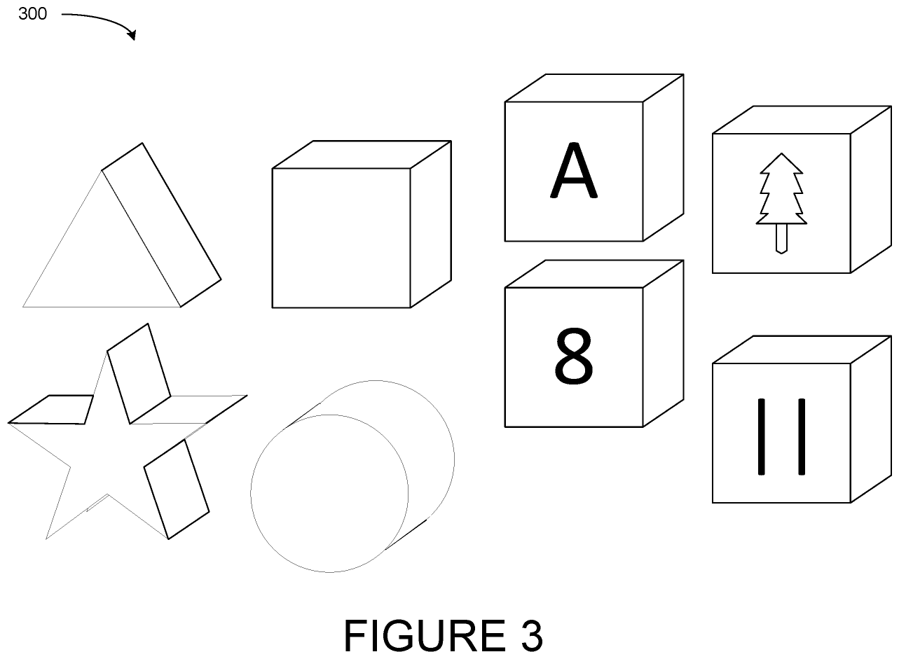

FIG. 3 is an illustration of a plurality of play blocks, according to an example embodiment. In particular, FIG. 3 shows a plurality of play blocks 300. As described above, a play device may provide an instruction to interact with physical object like the play blocks 300. The play blocks 300 may collectively have several characteristics that the play device can request in an instruction. This allows the user to use the play blocks 300 as inputs to a plurality of software coding prompts, and can also teach the user about the different characteristics of the play blocks 300. For example, the blocks may be different shapes and colors, and may include other types of information, such as letters, numbers, source code operators, or pictures of objects. In FIG. 3, a triangle-shaped block, a square-shaped block, a star-shape block, a circle-shaped block, an “A” block, an “8” block, an “H” block, and a “tree” block are shown. These characteristics can be organized into categories that can be leveraged by the play device to teach mathematics, language, or other topics.

FIG. 4 is an illustration of a play block, according to an example embodiment. In particular, FIG. 4 shows a play block 400 that includes an identifier 402. Within examples, the identifier 402 can be part of an RFID chip embedded in the play block 400, a bar code printed on a surface of the play block 400, a QR code printed on a surface of the play block 400, or another means of storing information for the play block 400 that is detectable by a sensor of a play device.

The identifier 402 may include information, such as a data structure that identifies one or more characteristics of the play block 400. For example, the identifier 402 may indicate a shape or color of the play block, may identify a category of the play block (e.g., a letter category or number category, or another type of object category), and/or may indicate a specific type of image printed on a surface of the play block 400. In this manner, the play device can instruct a user to find a block with a letter that is a vowel, a block with a number that is greater than 4, a block with a tree on it, or other particular characteristics of the block. The identifier 402 allows the play device to determine whether the instruction is successfully followed. As described above, these characteristics can be compared to desired characteristics in accordance with a source code operator. In other examples, the characteristics can be leveraged to complete mathematics problems, learn new words of a language, answer trivia for various subjects (e.g., What year did humans land on the moon?; or Which planet is closer to Earth? (1) Mars, (2) Jupiter, or (3) Saturn), or interact with other aspects of teachable subject matter (e.g., the play block 400 can be used to complete a physics equation, or to specify the elements in a molecule). Other uses of the play block 400 in conjunction with the play device are possible.

Though FIG. 4 shows a play block for use with a play device, other types of physical objects, such as tokens, coins, balls, cartridges, cards, or other objects can be configured to interact with the play device.

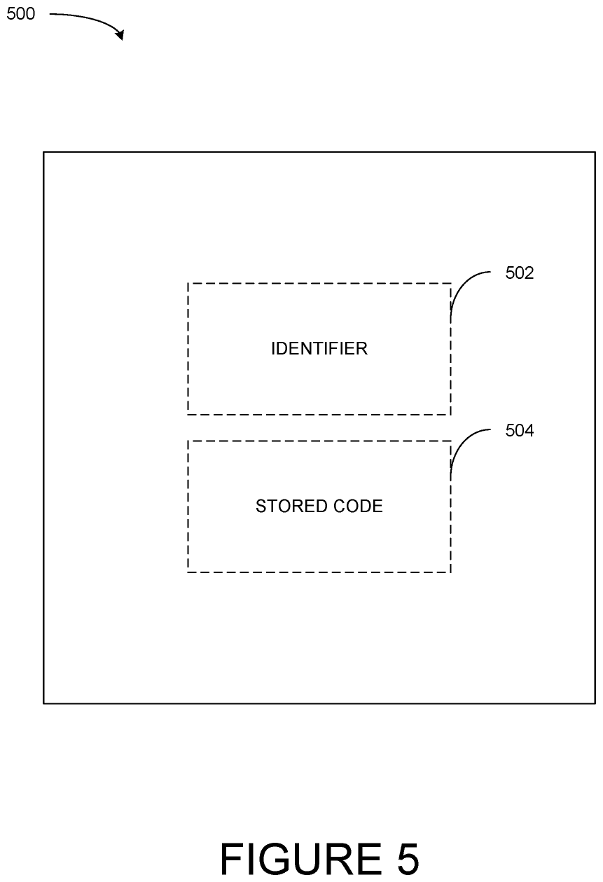

FIG. 5 is an illustration of a play block, according to an example embodiment. In particular, FIG. 5 shows a play block 500 that includes an identifier 502 a stored code 504. Within examples, the identifier 502 can be part of an RFID chip embedded in the play block 500, a bar code printed on a surface of the play block 500, a QR code printed on a surface of the play block 500, or another means of storing information for the play block 500 that is detectable by a sensor of a play device. The identifier 502 may operate in a similar manner to the identifier 402 of the play block 400 of FIG. 4.

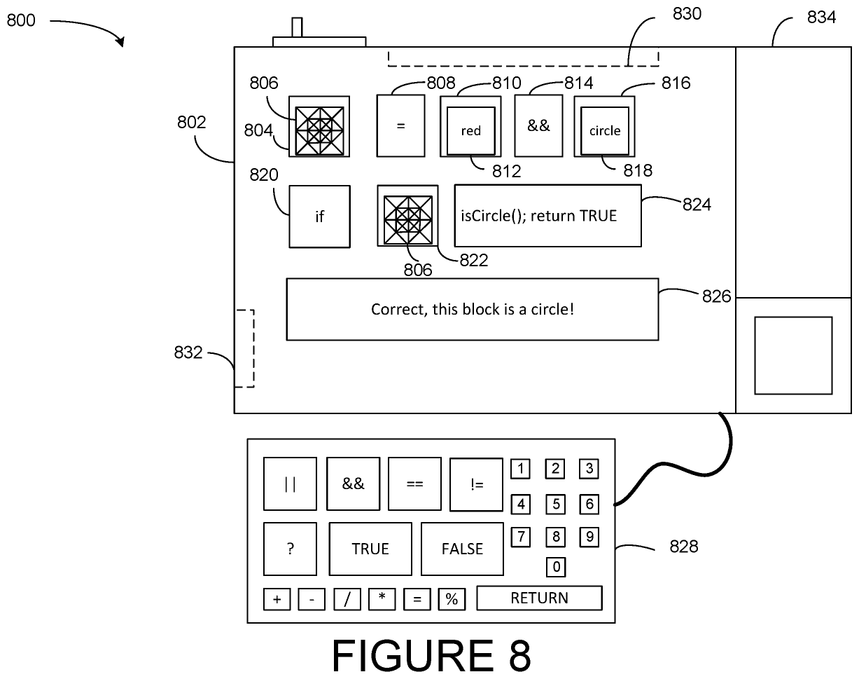

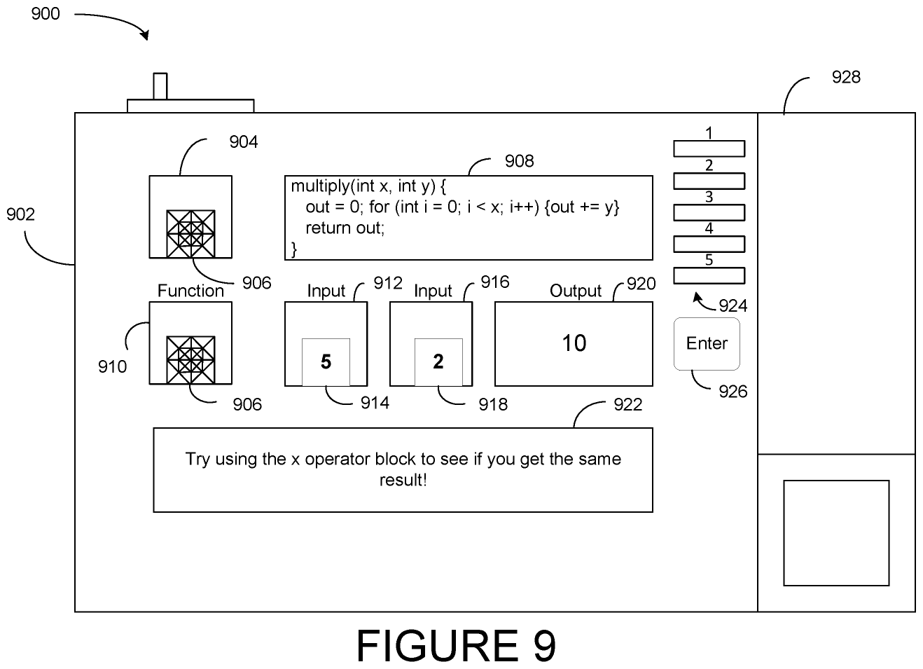

The stored code 504 can be stored on an RFID chip, a bar code, a QR code, or the like. Within examples, the stored code 504 is encoded by an encoder of the play device, such as an RFID encoder. This allows the play block 500 to serve as an input with a changeable value that can be set by the play device, or as a function that is used as a piece of source code for one or more operations of the play device. Further details regarding this functionality of the play block 500 is described below with respect to FIGS. 8 and 9.

Though FIG. 5 shows a play block for use with a play device, other types of physical objects, such as tokens, coins, balls, cartridges, cards, or other objects can be configured to interact with the play device.

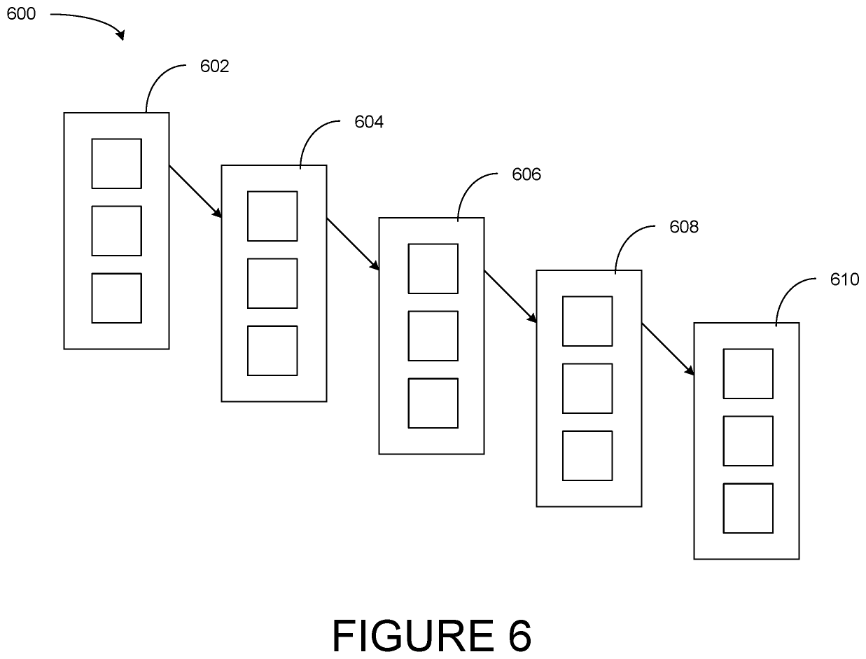

FIG. 6 is an illustration of a plurality of sets 600 of play blocks, according to an example embodiment. In particular, FIG. 6 shows a first set 602 of play blocks, a second set 604, a third set 606, a fourth set 608, and a fifth set 610. More or fewer sets of play blocks are possible. Each set of play blocks may correspond to a cartridge that can be inserted into a play device to serve as a block dispenser of the play device that dispenses play blocks.

The plurality of sets 600 of play blocks may correspond to a progression of learning goals for a user. As the user succeeds in understanding certain concepts or learning new words (e.g., surpassing a threshold percentage of correct answers, unlocking a target difficulty level, or surpassing a threshold number of points), new blocks can be dispensed from a set of blocks. The new blocks can serve as a reward for proficient use of the play device, but also may allow for more complex instructions from the play device. For example, the first set 602 of play blocks may include images of an alphabet, the second set 604 may include images of numbers, the third set may include source code operators, the fourth set may include images of animals, and so on. This progression of sets of play blocks may be predetermined, may be based on preferences of the user (e.g., set in an application stored on a computing device), or may be determined based on an analysis of data from the play device indicative of how well the user is understanding certain concepts. For example, if the user is answering mathematical instructions correctly more often than answering source code operator questions correctly, then the play device or a computing device associated with the play device may select the set of play blocks with numbers for being dispensed before the set of play blocks with source code operators. Other examples of determining sets of play blocks are possible. As described further below, the play device may track which play blocks are dispensed in order to limit its instructions to those that relate to blocks which are already dispensed (e.g., if alphabet blocks are not yet dispensed, the play device might refrain from instructing the user to find a block with a picture of a consonant).

Though FIG. 6 shows sets of play blocks for use with a play device, other types of physical objects, such as tokens, coins, balls, cartridges, cards, or other objects can be configured to interact with the play device.

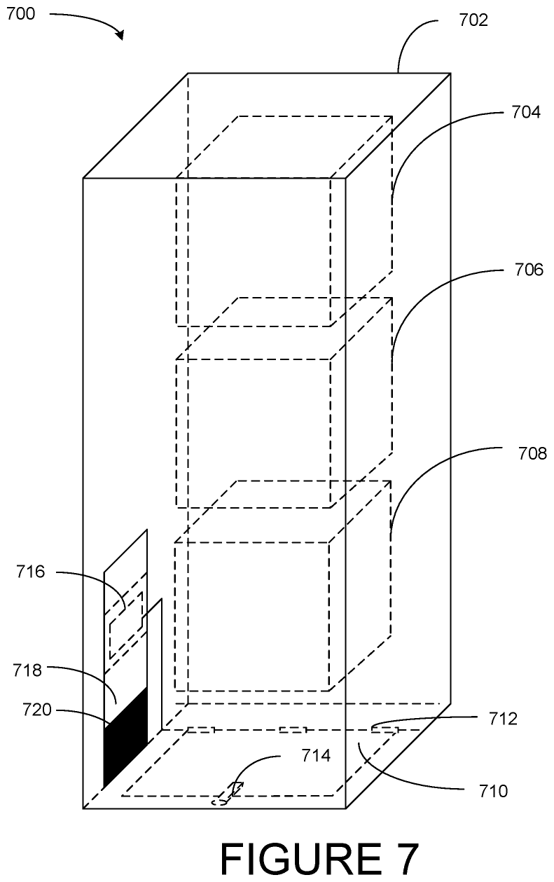

FIG. 7 is an illustration of a set of play blocks, according to an example embodiment. In particular, FIG. 7 shows a cartridge 700 for a block dispenser of a play device. The cartridge 700 includes a housing 702 that contains a plurality of play blocks, including a first play block 704, a second play block 706, and a third play block 708. The plurality of play blocks may each be configured in a similar manner to the play block 400 or the play block 500 described above with respect to FIGS. 4 and 5, respectively. The plurality of blocks may each include a common characteristic. For example, each block may include a picture of a number, a letter, or a type of object (e.g., an animal, a building, a vehicle, etc.). The cartridge is configured to interface with the play device in order to dispense the set of play blocks.

The cartridge 700 further includes a dispensing mechanism, which includes a door 710, a plurality of hinges 712, and a lock 714, which are collectively configured to contain the set of blocks until a signal is received from the play device. Each received signal may cause the dispensing mechanism to dispense a single play block.

The cartridge 700 further includes a control interface for the play device. The control interface includes an electric contact 716, a slider 718, and a mechanical contact 720. The electric contact may be a conductive material (e.g., a metal) configured to contact a corresponding electric contact on the play device when the cartridge 700 is inserted into a portion of the play device. For example, the play device may include a space shaped to fit the cartridge 700, so that the cartridge 700 can be placed into the space. When the cartridge 700 is placed into the space, the mechanical contact (e.g., a lip on the housing 702) may interface with a corresponding mechanical contact of the play device (e.g., a lip on a housing of the play device), thereby causing the slider 718 to expose the electric contact 716. This allows the electric contact 716 to interface with the play device after the cartridge 700 is inserted into the play device, so that the play device can control when play blocks are dispensed.

The electric contact 716 is connected to the dispensing mechanism (e.g., one or more of the lock 714 and the plurality of hinges 712), and can control the dispensing mechanism based on control signals from the play device. In this manner, different cartridges can be inserted or removed from the play device as blocks are dispensed, allowing a user to progress from one set of play blocks to another. For example, the set of play blocks in the cartridge 700 may be one of a plurality of sets of play blocks, as described above with respect to FIG. 6.

Though a specific implementation of the dispensing mechanism and the control interface of the cartridge 700 are depicted in FIG. 7, it should be understood that other ways of dispensing play blocks are possible. In some examples described herein, a block dispenser is described. The cartridge 700 can also be a part of an object dispenser of a play device (e.g., the object dispenser 226 of the play device 200).

FIG. 8 is an illustration of a play device, according to an example embodiment. In particular, FIG. 8 shows a play device 800 configured to interact with one or more physical objects. The play device 800 encodes information onto physical objects to allow for problem solving and enhanced interactivity, as described further below. The play device 800 includes a housing 802, a first area 804, a first visual interface 808, a second area 810, a second visual interface 814, a third area 816, a third visual interface 820, a fourth area 822, a fourth visual interface 824, and a fifth visual interface 826. Having multiple areas and user interfaces allows for adaptive use of physical objects to interact with the play device 800. For example, this may be facilitated by having different areas sense and/or encode information on the physical objects at different stages of carrying out an instruction.

FIG. 8 also shows a plurality of physical objects that are placed in different areas of the play device 800 at different times. In particular, a first play block 806, a second play block 812, and a third play block 818 are shown. The first play block 806 is a variable play block that can be encoded to reflect one or more characteristics of an object class. For example, an audio instruction may instruct the user to create a new block object using a variable block by placing a variable block in the first area 804, and to set one or more characteristics of the block using the second area 810 and the third area 816. In the example scenario depicted in FIG. 8, the instruction includes a prompt to store a color characteristic and a shape characteristic for the variable block (the first play block 806), and the user selected a red block (the second play block 812) and a circle block (the third play block 818) for use with the variable block. The = operator in the first visual interface 808 and the && operator in the second visual interface 814 provide additional information about the new object. In particular, these show that the new object includes both a red color characteristic and a circle shape characteristic. Placing the blocks in the areas specified in the audio instruction causes the play device or a computing device thereof to create a new software object that contains the red color characteristic and the circle shape characteristic, and this can be stored on the first play block 806 using an encoder (e.g., an RFID encoder) in the first area 804. In this manner, the play device 800 can use physical objects to convey the concept of software object classes and creating a new software object.

The third visual interface 820, the fourth area 822, and the fifth visual interface 826 collectively form a line of source code that correspond to an instruction for the user. In the example scenario depicted in FIG. 8, after creating the new object by encoding the first play block 806, the user is instructed to place the first play block 806 in the fourth area 822, the third visual interface 820 displays an if statement, and the fourth visual interface 824 displays a function to apply to the first play block 806 in accordance with the if statement. The user, having used the first play block 806 to complete the line of source code, may be prompted to execute the line to determine a result of executing the line of source code, or may be prompted to predict a result of executing the line of source code.

FIG. 8 further shows an input device 828. The input device 828 is depicted as a keyboard, but other interfaces, such as a touchscreen, are possible. In the example shown in FIG. 8, the user selects the TRUE key on the input device 828 to predict that the output of the line of source code will be TRUE. For example, an audio instruction may prompt the user to predict whether the output will be TRUE or FALSE. In response to the TRUE input from the input device 828, the play device or a computing device thereof compares the predicted output from the input device 828 to an actual result of executing the line of source code completed using the first play block 806, and displays an indication of the result along with an indication of whether the instruction was correctly followed. In particular, a fifth visual interface 826 states “Correct, this block is a circle!” to indicate that the user correctly predicted the result of executing the line of source code.

The input device 828 includes a plurality of source code operators, numbers, Boolean outputs, and a return key. These allow the user to enter various inputs in accordance with instructions from the play device 800. For example, the user may enter an = operator when prompted by the play device 800 in order to display the = operator in the first visual interface 808 and may enter an && operator when prompted by the play device 800 in order to display the && operator in the second visual interface 814. Accordingly, the user can enter aspects of the instruction manually in order to set up the problem. This can allow the user to learn aspects of coding in a controlled manner, where play blocks are used as variables and/or inputs and the input device 828 is used for entering relevant operators.

Though a keyboard is depicted for providing inputs in FIG. 8, play blocks can additionally or alternatively be used as inputs. For example, the user can place a TRUE block in an area 830 to predict the result of executing the line of source code. As shown in FIG. 2A, the play block leaves the play device 800 via an exit 832. Further, as shown in FIG. 2A, a block dispenser 834 is shown that can be used for dispensing variable blocks for the user as the user progresses (e.g., by achieving a threshold score at least in part based on accurately predicting the result of executing the line of source code).

Accordingly, FIG. 8 shows an example in which a user is guided through the process of creating a new software object and/or setting a value for a variable, and then constructing a line of source code. A physical object is used to demonstrate this process in a tangible way that is understandable to the user. Then the user is instructed to predict the outcome of executing the line of source code based on the value of the play block to show the user understands how the value set for the play block interacts with a function in the line of source code. The play device 800, a computing device thereof, or an application on another computing device (e.g., a tablet or a mobile phone) can be used to show the user that these concepts have been learned, and reward the user's progress with points, new play blocks, or other rewards. Similarly, the play device 800 may provide visual or audio encouragement for the user, such as with animations and/or sound effects.

Though FIG. 8 shows a particular arrangement of areas of the play device 800, in alternative examples may include more or fewer areas for sensing and/or encoding play blocks. For example, a single area and a single user interface (e.g., a single visual and/or audio interface) can be used to interact with the play blocks at different times in order to simplify the user's interactions with the play device 800. Other configurations of the play device 800 are possible.

FIG. 9 is an illustration of a play device, according to an example embodiment. In particular, FIG. 9 shows a play device 900 configured to interact with one or more physical objects. The play device 900 encodes information onto physical objects to allow for problem solving and enhanced interactivity, as described further below. The play device 900 includes a housing 902, a first area 904, a first visual interface 908, a second area 910, a third area 912, a fourth area 916, and a second visual interface 920. Having multiple areas and user interfaces allows for adaptive use of physical objects to interact with the play device 900. For example, this may be facilitated by having different areas sense and/or encode information on the physical objects at different stages of carrying out an instruction.

FIG. 9 also shows a plurality of physical objects that are placed in different areas of the play device 900 at different times. In particular, a first play block 906, a second play block 914, and a third play block 918 are shown. The first play block 906 is a function play block that can be encoded to serve as one or more lines of source code. For example, an audio instruction may instruct the user to save a software function on a function block by placing the function block in the first area 904. The software function is displayed on the first visual interface 908 and the instruction may prompt the user to consider what the software function does. In the present example, the software function is operable to multiply two inputs using a for loop and incremental operators. Placing the first play block in the first area 904 as specified in the instruction causes the play device 900 or a computing device thereof to store the software function on the first play block 906 using an encoder (e.g., an RFID encoder) in the first area 904. In this manner, the play device 900 can use physical objects to convey the concept of software functions.

After encoding the first play block 906 with a software function, the play device 900 instructs the user to place the first play block 906 in the second area 910, and to place one or more additional play blocks in the third area 912 and the fourth area 916 to serve as inputs to the software function of the first play block 906. In the present example, the second play block 914 shows the number 5, and the third play block 918 shows the number 2. The second visual interface 920 displays a result of executing the software function of the first play block 906 using the second play block 914 and the third play block 918 as inputs. In the present example, the output is the number 10. A third visual interface 922 shows a further instruction to “Try using the x operator to see if you get the same result!” In this manner, the play device 900 or a computing device thereof can show further details of the nature of a software function and/or source code operators. Further, the play device 900 allows a user to use a physical object as a software function to emphasize that a software function is a piece of code that can be moved or re-used in a software program after being defined a single time.

Though a multiplication function is shown in FIG. 9, other types of mathematical or non-mathematical functions can be implemented using the play device 900. For example, functions used to indicate characteristics of an input block can be encoded on play blocks. An example of these functions can include a function to determine if a letter block is a vowel or a consonant, a category function to determine a category of a play block (e.g., a letter block, a number block, an operator block, an animal block, etc.), a function to determine if a block is odd or even, or another function that allows a user to explore characteristics of a block. Other types of software functions are possible.

The play device 900 further includes a plurality of memory slots 924. The plurality of memory slots 924 can be used for storing software objects or other values, and can be used for teaching the concept of source code references and/or source code pointers. For example, an & operator or a * operator can be used in conjunction with the plurality of memory slots 924 to show that a value is stored in a given memory slot, and that the stored value is not necessarily the same as a value indicating a location of the memory slot. For example, a first memory slot can be labelled with a number 1, but might store a number 5 that is referenced by a software function executed by the play device 900 or a computing device thereof.

The play device 900 further includes an enter button 926, which allows a user to execute a function when they believe they have successfully followed an instruction from the play device 900. Further, as shown in FIG. 2A, a block dispenser 928 is shown that can be used for dispensing function blocks for the user as the user progresses (e.g., by achieving a threshold score at least in part based on reviewing and testing different software functions).

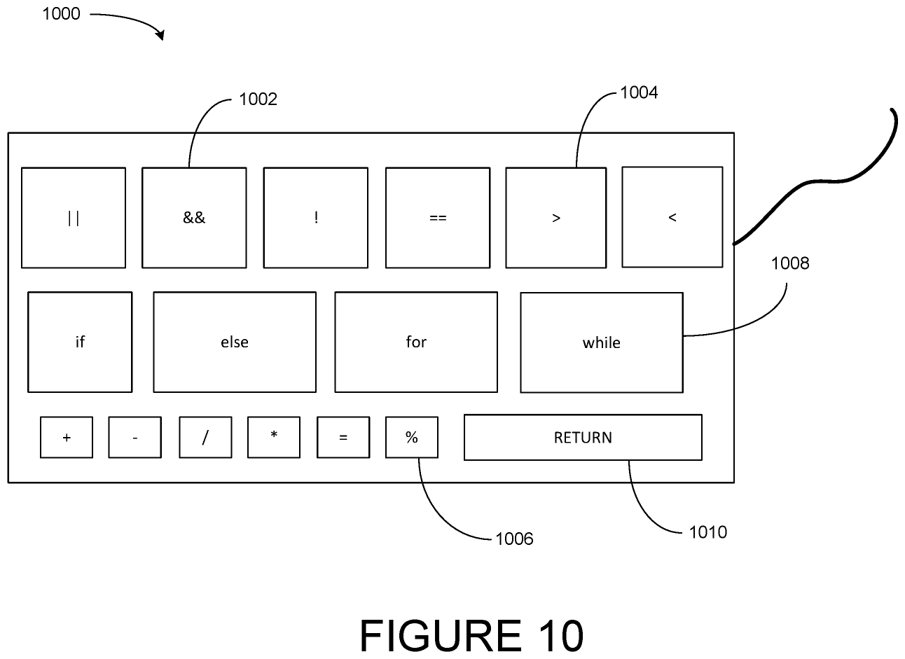

FIG. 10 is an illustration of an input device for a user interface of a play device, according to an example embodiment. In particular, FIG. 10 shows a keyboard 1000 that includes source code operators, and source code statements, and a return key. This specialized keyboard is configured for use with a play device for teaching software concepts, and allows a user to input relevant operators or statements as needed to follow instructions for the play device. In the present example the keyboard 1000 includes a plurality of logical operator keys 1002 (∥, &&, and !), a plurality of comparative operator keys 1004 (==, >, and <), a plurality of mathematical operator keys 1006 (+, −, /, *, =, and %), a plurality of source code statement keys 1008 (if, else, for, while), and a return key 1010.

Though the keyboard 1000 may include additional keys, such as letter keys or number keys, in some examples the keyboard 1000 may consist of only source code operator keys, source code statement keys, or a combination of these with a return key. This may allow the keyboard 1000 to be suited more specifically with a play device and allow one or more physical objects to serve as inputs while completing certain lines of source code with the keyboard 1000 in conjunction with instructions from the play device.

Though the systems, play devices, and play blocks shown in FIGS. 2A-10 show particular configurations of areas for placing physical objects and visual interfaces for displaying aspects of instructions for a user of the play device, other configurations are possible. For example, in some examples the play device may include an audio interface (e.g., a microphone) instead of a visual interface (e.g., a digital display). In other examples, audio interfaces may be used for examples targeted for blind users that use objects having brail or other textured surfaces configured to convey characteristics of the objects. This may also be useful for users that are attempting to avoid screen time. Accordingly, other types of visual interfaces, such as buttons and/or lights can be used to show aspects of an instruction from a play device. Other configurations of the play devices are possible.

Further, it should be understood that the configurations of play devices depicted in FIGS. 2A, 8, and 9 are provided to emphasize certain aspects of functionality of a play device, and various features of these examples can be added, omitted, exchanged, or combined. Also, as noted above, the physical objects used for interacting with a play device may have alternate configurations to the play blocks depicted in the Figures. For example, tokens, coins, balls, cartridges, cards, or other objects are possible. Play devices, areas of the play devices, and object dispensers of the play devices may be configured to interact with any of these other types of physical objects in addition to or alternatively to interacting with play blocks.

### III. EXAMPLE VIRTUAL ENVIRONMENTS

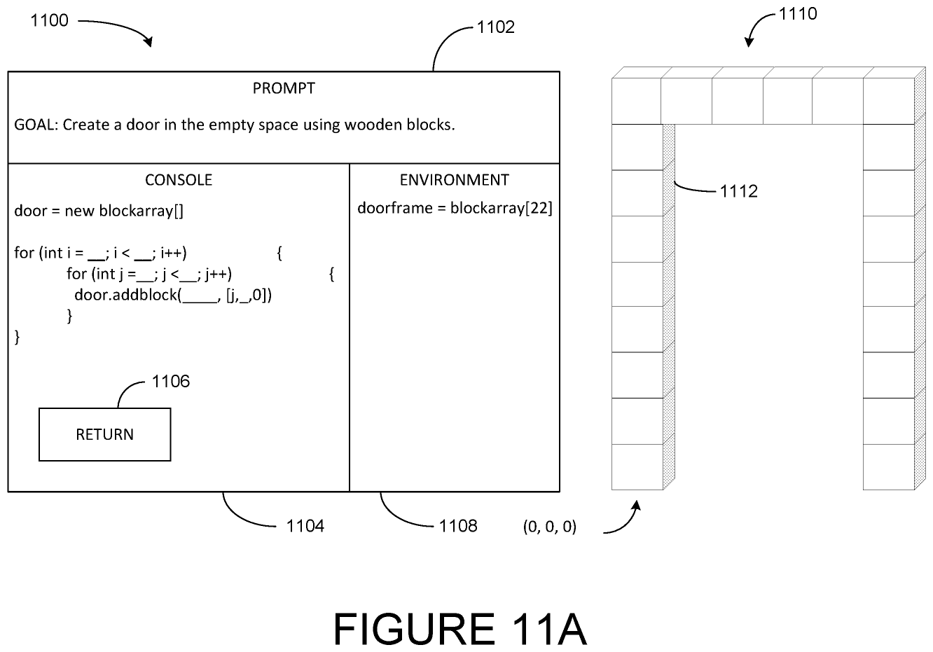

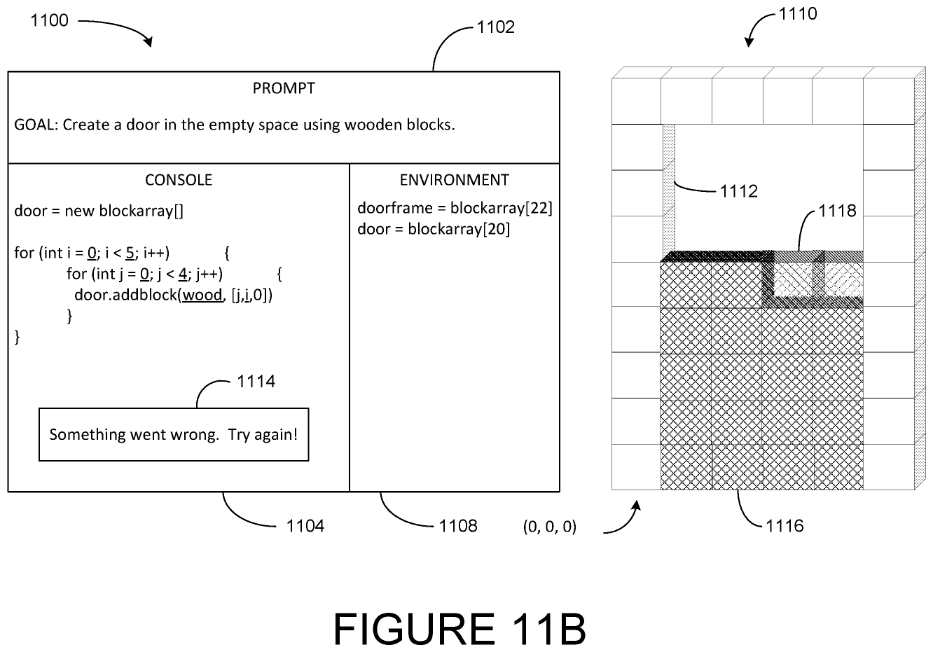

FIG. 11A is an illustration of a virtual environment at a first time, according to an example embodiment. In particular, FIG. 11 shows a virtual environment 1100 that is used for teaching coding concepts to a user. The above-described examples relate to using a physical object to convey aspects of software coding. The virtual environment 1100 is configured to show how entering source code alters one or more aspects of the virtual environment 1100. A representative example scenario is presented in FIG. 11A.

The virtual environment 1100 may be a two-dimensional (2D) representation of a three-dimensional (3D) environment (e.g., using a screen associated with a gaming console or personal computer), or a 3D representation of the 3D environment (e.g., using a virtual-reality headset). For example, a computing device configured in a similar manner to the computing device 104 can be used to present the virtual environment 1100. The virtual environment 1100 includes a representation of a coding interface, which includes a prompt window 1102, a console window 1104, and an environment window 1108. The virtual environment 1100 also includes virtual features that the user can interact with by coding in accordance with an instruction.

In the example scenario, the prompt window 1102 instructs the user to “Create a door in the empty space using wooden blocks.” A doorframe 1110 composed of a plurality of blocks 1112 is provided to give the user an indication of where the door should be located in the virtual environment 1100.

The console window 1104 includes partially populated source code with blank spaces that allow the user to use an input interface (e.g., a keyboard, a virtual keyboard, or another interface) to enter source code in order to follow the instruction from the prompt window 1102. The console window 1104 also include a virtual return key 1106 allowing the user to cause a computing device (e.g., a gaming console, a personal computer, a remote server, or another device) to execute the source code once the blank spaces have been filled.

FIG. 11B is an illustration of a virtual environment at a second time, according to an example embodiment. In particular, FIG. 11B shows the virtual environment 1100 after the user fills blank spaces in the source code and engages the virtual return key 1106.

At the second time, the console window 1104 shows what has been entered into the blank spaces and includes an indicator 1114 that tells the user “Something went wrong. Try again!” The indicator 1114 can provide additional information about for loops, or hints for successfully following the instruction. The environment window 1108 shows that the user has created an array of virtual blocks having 20 block objects. The virtual environment 1100 also shows a result of executing the source code. In particular, at the second time, an animation is progressing to visualize what the source code does to the virtual environment 1100. At the second time, a plurality of virtual blocks 1116 have already been added during the animation and a plurality of placeholder blocks 1118 remain to show what the door will look like after the source code is finished executing. Placing the virtual blocks 1116 in this manner during the animation gives an impression of how for loops function, and gives an impression of changes that the user can make to successfully complete the instruction. For example, in the scenario depicted in FIG. 11B, the user sees that not enough rows of virtual blocks are placed, and can change one or more inputs to complete the door.

FIGS. 11A and 11B show a particular example of showing an effect on a virtual environment caused by completing source code in the console window 1104. In other examples, different coding concepts can be illustrated for the user in many contexts. For example, different coding prompts can be provided to a user at different points in a game to teach if statements, for loops, while loops, references, pointers, creation of object classes, data structures, software functions, recursive functions, and other fundamental coding concepts. A software language (C++, Java, Python, etc.) can be changed based on a user's preference to show differences in software language syntax while performing similar coding tasks.

A computing device associated with the virtual environment 1100 can give the user relevant prompts to interact with the virtual environment 1100 depending on a context of a game. For example, the user can alter characteristics of a game character, a piece of equipment, an item, or other aspects of the environment in response to encountering an enemy, a type of object (e.g., a building), a game context (e.g., a transition from day to night), a type of virtual material (e.g., water or fire), a new type of game physics (e.g., reduced gravity), a new game level, or other gaming contexts, each of which can serve as a prompt to learn a coding lesson.

Within examples, interacting with the virtual environment 1100 with a coding prompt may allow the user to create an object with code that was previously inaccessible to the user. For example, in the scenario of FIGS. 11A and 11B, the user may gain the ability within a game to create and place doors in the virtual environment 1100 (e.g., in other parts of an open world game). The user may gradually accumulate classes of software objects to use in the game, the practical value of which may increase as a difficultly level of coding prompts increases. In some contexts, this can allow the user to perform game development tasks, thus teaching the user about game design while the user plays the game. The virtual environment 1100 may also show aspects of a computing device (e.g., available stack memory, heap memory, CPU time, etc.) indicative of performance of the computing device while executing aspects of game code. In this manner, a user can learn fundamental coding concepts while also becoming cognizant of practical implications of software development.

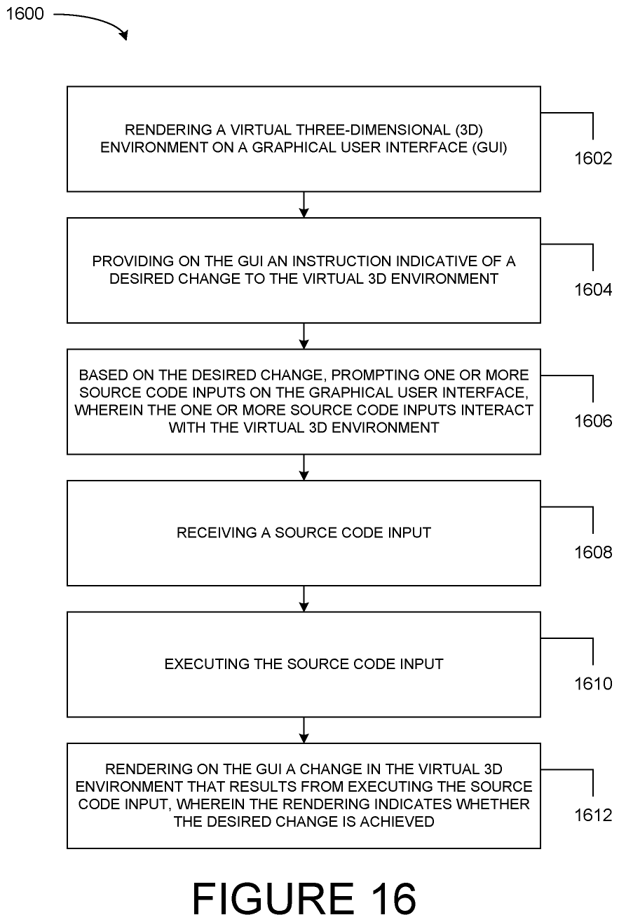

Accordingly, FIGS. 11A and 11B show an example scenario involving a computing device used for teaching software coding concepts and for providing a virtual representation of an environment. The example scenario illustrates aspects of issues particularly encountered in software education scenarios in which learners may not intuitively grasp new concepts. The computing device is configured to overcome these issues by providing a “tangible” visual output that mimics a physical change in an environment in response to inputs from the user. Accordingly, the examples described with respect to FIGS. 11A and 11B (and with respect to FIG. 16 described below) provide similar improvements in education technology to those described with respect to FIGS. 1-10, which use physical objects as inputs for a play device to encourage users to learn coding concepts.

### IV. EXAMPLE SOFTWARE APPLICATIONS

FIG. 12 is an illustration of a computing device having an application stored thereon that is configured to interact with a play device, according to an example embodiment. In particular, FIG. 12 shows a computing device 1200 with a user interface 1202 that displays an example software application. The software application can be used for tracking a user's learning progress, and can interface with a play device or a computing device thereof.

The software application includes a score 1204 that shows points accumulated by a given user based on successfully following instructions of the play device (e.g., each time the user successfully follows an instruction, the score can increment by one or more points). Apart from tracking progress of the user, the points may be used for one or more rewards, such as a new set of blocks. The software application shows that the next reward for the user is 5000 points. The software application also indicates how many coding concepts have been learned by the user, and what percent of instructions the user correctly follows over time.

Further, the application can include a plurality of prompts 1210, including a prompt to view suggested blocks (or other physical objects) to use with the play device, a prompt to select one or more coding lessons to add to the play device, a prompt to practice a new language (e.g., a software language or a new human language), and a prompt to configure aspects of the play device (e.g., a play mode, a difficulty level, desired sound effects, etc.). These and other prompts allow the software application to send control instructions to a computing device of the play device and thereby control aspects of how the play device operates. Additionally, the software application can allow a user to customize the learning experience by selecting particular play blocks to order, or particular lessons or languages to learn.

### V. EXAMPLE METHODS

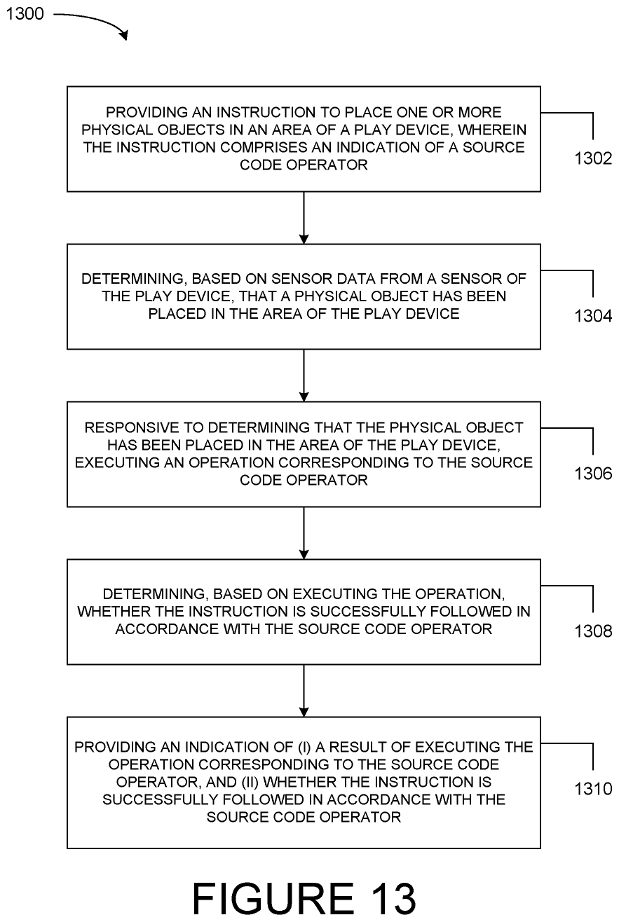

FIGS. 13-18 are flow charts illustrating example methods 1300, 1400, 1500, 1600, 1700, and 1800. These methods may be carried out by any of the systems, devices, or components thereof described above with regard to FIGS. 1-12.

In addition, for the methods shown in FIGS. 13-18 and other processes and methods disclosed herein, each flow chart shows functionality and operation of one possible implementation of present embodiments. In this regard, some blocks may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the methods and other processes and methods disclosed herein, each block in FIGS. 13-18 may represent circuitry that is wired to perform the specific logical functions in the process.

FIG. 13 is a block diagram of a method, according to an example embodiment. In particular, FIG. 13 shows a flow chart of method 1300 for teaching software concepts. At block 1302, the method 1300 includes providing an instruction to place one or more physical objects in an area of a play device. The instruction includes an indication of a source code operator. For example, the instruction may be provided by way of a visual or audio interface, as shown in FIG. 2A.

At block 1304, the method 1300 includes determining, by a computing device based on sensor data from a sensor of the play device, that a physical object has been placed in the area of the play device. For example, a computing device within the play device or remote from the play device may use the sensor data to determine that a physical object has passed through the area (e.g., using an RFID sensor, a bar code scanner, a QR code scanner, or another sensor).

At block 1306, the method 1300 includes, responsive to determining that the physical object has been placed in the area of the play device, executing, by the computing device, an operation corresponding to the source code operator. For example, the instruction may include an indication of a logical operator, a comparative operator, or a mathematic operator, and the operation may include one or more lines of source code including the operator indicated in the instruction.

At block 1308, the method 1300 includes determining, by the computing device based on executing the operation, whether the instruction is successfully followed in accordance with the source code operator. For example, the computing device can determine an output of executing one or more lines of code using an input value associated with the physical object (e.g., a characteristic of the physical object) and compare the output to an expected output. If the output matches the expected output, the computing device can determine that the instruction is successfully followed. Otherwise, the computing device can determine that the instruction is not successfully followed.

At block 1310, the method 1300 includes providing an indication of (i) a result of executing the operation corresponding to the source code operator, and (ii) whether the instruction is successfully followed in accordance with the source code operator. For example, this may be performed by displaying the indication on a visual interface as shown in FIGS. 2B-2F, or using an audio interface (e.g., a speaker).

Within examples, the method 1300 further includes determining one or more characteristics of the physical object. For example, the one or more characteristics can include a shape or color of the physical object determined from the sensor data. In these examples, the method 1300 further includes representing the physical object by setting a value of a software object variable using the one or more characteristics. For example, this may involve creating a new object in an object class that represents the one or more characteristics. In these examples, executing the operation corresponding to the source code operator includes using the software object variable representing the physical object as an input to the software function.

In related examples, the method 1300 may further include providing a first visual animation on the play device that illustrates the one or more characteristics of the physical object being represented by the software object variable. For example, an animation of a shape and/or color and/or an image of the physical object can be shown on a visual interface (e.g., a digital display) of the play device. In these examples, the method 1300 further includes providing a second visual animation on the play device that illustrates the software object variable representing the physical object being used as the input to the software function. For example, a pseudo-code or source code representation of the software object variable can be provided. In these examples, providing the indication of the result of executing the operation corresponding to the source code operator includes providing a visual animation of comparing a desired output of executing the operation to an output of using the software object variable representing the physical object being used as the input to the software function. For example, a visual representation of the desired output can be provided next to a representation of the output. This can emphasize whether the instruction is successfully followed.

Within examples, the instruction includes an audio indication of the source code operator and an audio indication of a desired characteristic of the physical object in connection with the source code operator. In these examples, the method 1300 further includes determining, by the computing device, a characteristic of the physical object after the physical object is placed in the area of the play device. For example, the characteristic can be a shape, color, or image associated with the physical object detected from an identifier of the physical object. In these examples, executing the operation corresponding to the source code operator includes executing the operation based on the characteristic of the physical object. the result of executing the operation includes comparing an output of executing the operation to an output associated with the desired object characteristic. For example, the instruction can include an ∥, &&, or ! operator and a particular shape, color, letter, number, etc. of a physical object might be desired. Executing the operation may include testing the characteristic of the physical object to determine if the operation returns a Boolean TRUE output, when the operation would return a TRUE output if the characteristic of the object matched the desired characteristic. In these examples, the physical object can be a play block associated with the play device, the play block can include a radio-frequency identification (RFID) tag, and determining the characteristic of the physical object includes determining the characteristic based on an identifier stored on the RFID tag.

In related examples in which the physical object is a play block associated with the play device, the play block can include an identifier indicative of the characteristic, and the area of the play device includes the sensor. In these examples, the method 1300 further includes detecting the identifier using the sensor, wherein the sensor data represents the identifier, and determining the characteristic based on detecting the identifier using the sensor. For example, the characteristic may include one or more of a shape of the play block, a color of the play block, or an image printed on the play block, and this information can be stored on the identifier.

Within examples, the source code operator includes an increment operator or a decrement operator, and the instruction includes an instruction to place multiple physical objects in the area of the play device until reaching a desired result (e.g., a desired number). In these examples, executing the operation corresponding to the source code operator includes iteratively executing an operation corresponding to the increment operator or the decrement operator, and providing the indication of the result of executing the operation corresponding to the source code operator includes providing a visual indication of an incremented or decremented output number for each physical object placed in the area of the play device. For example, this can be performed as described above with respect to FIG. 2B.

Within examples, the source code operator includes a logical operator, the instruction includes an instruction to place a physical object having a desired characteristic in accordance with the logical operator, executing the operation corresponding to the source code operator includes executing the logical operator using the desired characteristic as an operand for the logical operator, and providing the indication of the result of executing the operation corresponding to the source code operator includes providing a visual indication of a Boolean output of executing the operation corresponding to the source code operator. For example, this can be performed as described above with respect to FIGS. 2C and 2D.

Within examples, the source code operator includes a comparison operator, the instruction includes an instruction to place a physical object having a desired characteristic in accordance with the comparison operator, executing the operation corresponding to the source code operator includes executing the comparison operator using the desired characteristic as an operand for the comparison operator, and providing the indication of the result of executing the operation corresponding to the source code operator includes providing a visual indication of a Boolean output of executing the operation corresponding to the source code operator. For example, this can be performed as described above with respect to FIG. 2E.

Within examples, the source code operator includes a mathematical operator, and the instruction includes an instruction to place a physical object having a desired numerical characteristic in accordance with the mathematical operator. For example, the instruction can include an algebraic equation and request a physical object that solves for a variable of the equation. In other examples, two or more numbers can be added, subtracted, multiplied, divided, or a combination of these, and the user can be prompted for an output number. Other mathematic instructions are possible.

Within examples, the play device includes a plurality of play modes. In these examples, the method 1300 further includes randomly selecting the source code operator for the instruction from a set of source code operators associated with a current play mode of the play device. For example, a first mode may include incremental or decremental operators and may focus on counting play blocks, a second mode may include logical operators and/or comparative operators and may focus on finding play blocks with particular characteristics, and a third mode may include a combination of these operators and may focus on correctly determining a Boolean output. These different modes may allow for a user to focus on particular aspects of software coding, perhaps to emphasize a type of operator that the user is struggling to understand.

Within examples, the method 1300 further includes determining that the instruction is successfully followed in accordance with the source code operator, responsive to determining that the instruction is successfully followed in accordance with the source code operator, incrementing a score on the play device, and causing the play device to dispense a new physical object (i) responsive to determining that the instruction is successfully followed in accordance with the source code operator and (ii) based on incrementing the score on the play device past a threshold score. This can involve dispensing a new play block in response to detecting that a play block has been correctly placed in the area in accordance with the instruction. For example, this may be performed as described above with respect to FIG. 7.

Within examples, the computing device is configured to operate in a plurality of language modes, and, for each respective language mode: (i) the instruction includes a different audio instruction associated with a respective human language, and (ii) the instruction includes a visual indication of the source code operator that remains the same between different language modes. In this manner, the source code operator can be leveraged across different human language modes to allow a user to more readily understand instructions provided in a new human language.

Within examples, the computing device is configured to operate in a plurality of difficulty modes. In a first difficulty mode, the instruction includes an animation illustrating a desired characteristic of the physical object and wherein, in a second mode, the instruction includes a source code representation of the desired characteristic. For example, this difference is illustrated between FIGS. 2C and 2D

Within examples, method 1300 further includes establishing a record of dispensed blocks, wherein the record includes at least one characteristic of the block. In these examples, the method 1300 includes determining the instruction based on the record of dispensed blocks. For example, the play device can provide instructions that prompt for play blocks with characteristics that are available to the user. These available characteristics can be tracked as the user places different blocks into the area of the play device.

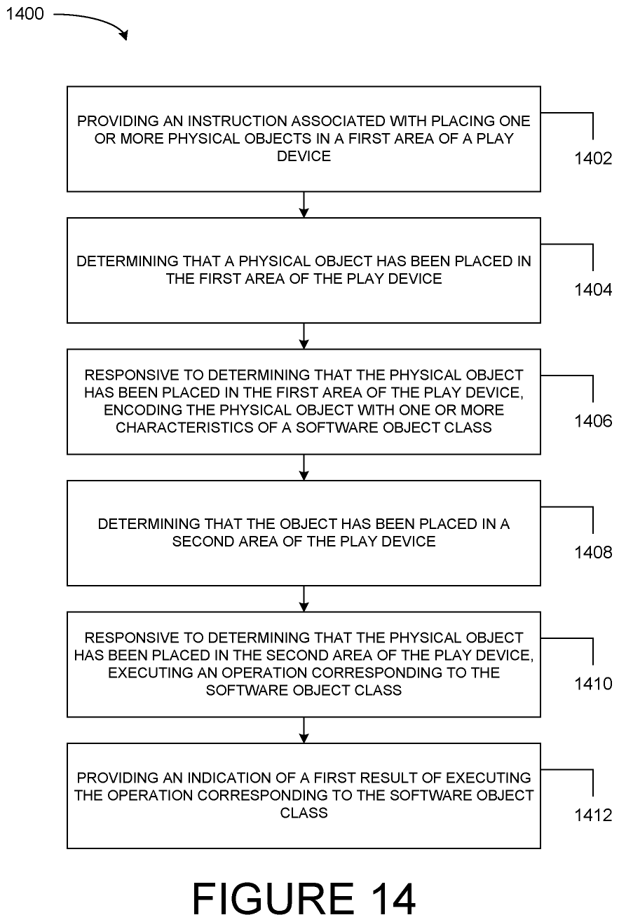

FIG. 14 is a block diagram of a method, according to an example embodiment. In particular, FIG. 14 shows a flow chart of a method 1400 for teaching software concepts. At block 1402, the method 1400 includes providing an instruction associated with placing one or more physical objects in a first area of a play device.

At block 1404, the method 1400 includes determining, by a computing device, that a physical object has been placed in the first area of the play device. For example, this can be determined based on a sensor data from a sensor of the play device.

At block 1406, the method 1400 includes responsive to determining that the physical object has been placed in the first area of the play device, encoding the physical object with one or more characteristics of a software object class. For example, the computing device can cause an encoder (e.g., an RFID) to encode the physical object (e.g., an RFID chip of the physical object). The characteristics can include a shape or color characteristic, a numerical value, a letter, or another characteristic associated with a software object class.

At block 1408, the method 1400 includes determining, by the computing device, that the object has been placed in a second area of the play device. For example, this can be determined based on a sensor data from a sensor of the play device.

At block 1410, the method 1400 includes, responsive to determining that the physical object has been placed in the second area of the play device, executing, by the computing device, an operation corresponding to the software object class.

At block 1412, the method 1400 includes providing an indication of a first result of executing the operation corresponding to the software object class. Blocks 1402-1412 can be performed similarly to the examples described above with respect to FIG. 8.

Within examples, encoding the physical object with one or more characteristics of the software object class includes setting first values for the one or more characteristics. In these examples the method 1400 further includes providing an instruction associated with returning the physical object to the first area of the play device, responsive to determining that the physical object has been returned to the first area of the play device, changing the first values of the one or more characteristics to second values, determining, by the computing device, that the object has been placed in a second area of the play device, responsive to determining that the physical object has been placed in the second area of the play device, executing, by the computing device, the operation corresponding to the software object class, and providing an indication of a second result of executing the operation corresponding to the software object class, wherein the second result is different from the first result. For example, the same physical object can be repeatedly encoded with different values in accordance with different instruction from the play device. As an example of this, the same play block can be used as a variable in multiple different algebra problems, and the user can repeatedly use the play block when solving the algebra problems. Other examples are possible.

Though FIG. 14 involves two different areas of a play device, a single area can be used and the same physical object can be placed in the area at different times. This may simplify the play device by reducing the number of areas of sensing and/or encoding physical objects.

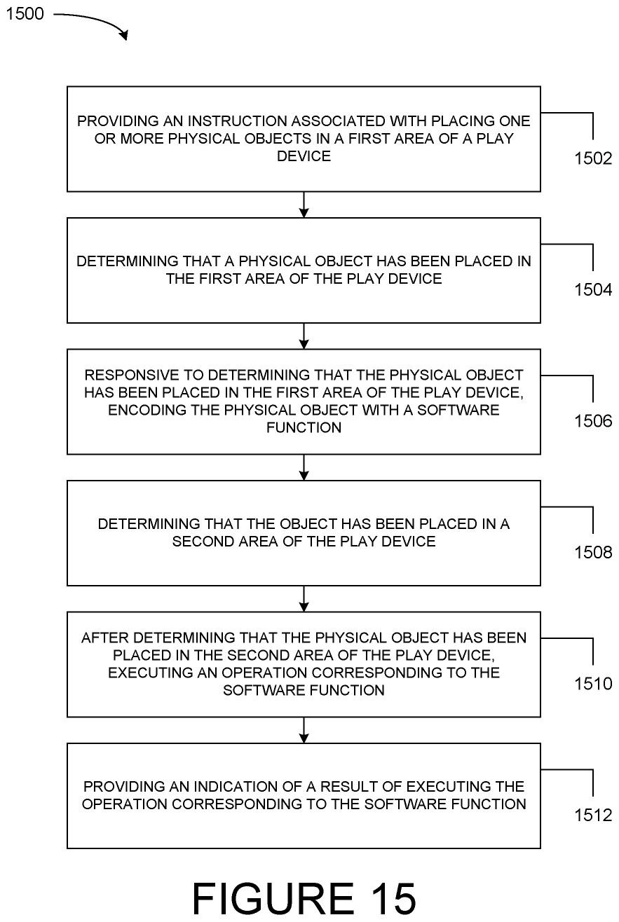

FIG. 15 is a block diagram of a method, according to an example embodiment. In particular, FIG. 15 shows a flow chart of a method 1500 for teaching software concepts. At block 1502, the method 1500 includes providing an instruction associated with placing one or more physical objects in a first area of a play device.

At block 1504, the method 1500 includes determining, by a computing device, that a physical object has been placed in the first area of the play device. For example, this can be determined based on sensor data from a sensor of the play device.

At block 1506, the method 1500 includes, responsive to determining that the physical object has been placed in the first area of the play device, encoding the physical object with a software function. For example, the computing device can cause an encoder (e.g., an RFID) encode to encode the physical object (e.g., an RFID chip of the physical object). The software function can include one or more lines of source code configured to interact with one or more inputs.

At block 1508, the method 1500 includes determining, by the computing device, that the object has been placed in a second area of the play device.

At block 1510, the method 1500 includes, after determining that the physical object has been placed in the second area of the play device, executing, by the computing device, an operation corresponding to the software function.

At block 1512, the method includes providing an indication of a result of executing the operation corresponding to the software function. Blocks 1502-1512 can be performed similarly to the examples described above with respect to FIG. 9.

Within examples, the physical object is a first object (e.g., of a plurality of objects). In these examples, the method 1500 includes determining that a second physical object has been placed in a third area of the play device. In these examples, executing the operation corresponding to the software function comprises using one or more characteristics of the second physical object as an input to the software function.

Within examples, the play device has a plurality of software language modes, and the instruction differs based on the software language mode.

Though FIG. 15 involves three different areas of a play device, a single area can be used and the same physical object can be placed in the area at different times. This may simplify the play device by reducing the number of areas of sensing and/or encoding physical objects.

FIG. 16 is a block diagram of a method, according to an example embodiment. In particular, FIG. 16 shows a flow chart of a method 1600 for teaching software concepts. At block 1602, the method 1600 includes rendering a virtual three-dimensional (3D) environment on a graphical user interface (GUI). For example, the 3D environment can include an area in a game, and a user can navigate within the 3D environment using an input device (e.g., a controller or a mouse and keyboard).

At block 1604, the method 1600 includes providing on the GUI an instruction indicative of a desired change to the virtual 3D environment. For example, the desired change can include adding a new feature to the environment or changing an existing feature of the environment.

At block 1606, the method 1600 includes, based on the desired change, prompting one or more source code inputs on the graphical user interface, wherein the one or more source code inputs interact with the virtual 3D environment. For example, a console within the GUI can emerge that includes source code having blank spaces for the user to fill.

At block 1608, the method 1600 includes receiving a source code input. For example, a user can enter source code into the blank spaces.

At block 1610, the method 1600 includes executing the source code input.

At block 1612, the method 1600 includes rendering on the GUI a change in the virtual 3D environment that results from executing the source code input, wherein the rendering indicates whether the desired change is achieved. For example, each line of the source code can be highlighted over time to show how different portions of the source code influence the virtual 3D environment. In this manner the user can visualize what the source code does.

Within examples, the method 1600 further includes, prior to providing the instruction, allowing a user to navigate within the virtual 3D environment, while providing the prompt, at least partially restricting movement of the user within the virtual 3D environment, determining that the desired change is achieved based on the source code input, and, responsive to determining that the desired change is achieved, removing movement restrictions of the user within the virtual 3D environment. This may encourage a user to complete a coding lesson by restricting the user's ability to play a game while completing source code, and returning the ability to play once the lesson is completed.

Within examples, the desired change is creation of a new object of an object class. In these examples, prompting the one or more source code inputs correspond to one or more characteristics of the object class, and rendering on the GUI the change in the virtual 3D environment that results from executing the source code input includes rendering a new object in the environment. For example, a new structure, piece of equipment, weapon, or interactive aspect of a game can be created by the user. The method may include updating a list of usable items with the new object. In this manner, the user can be encouraged to complete the lesson by being promised a reward (a new usable object) for completing the prompt.

In related examples, the object class can be a building block for a plurality of additional object classes. In these examples the method 1600 may further include prompting additional source code inputs corresponding to building additional object classes using the object class. The method 1600 may further include saving the new object to a list of available objects for the user to use in the virtual 3D environment. For example, the new object can include a block that is placed in the virtual 3D environment, and completing the prompt can allow the user to save a type of block that matches the new object to the list of available objects. In world building games, this may allow the user to construct new types of structures or interactive objects.

In related examples, the method 1600 further includes successively prompting source code inputs of increasing difficulty (e.g, based on a predetermined difficulty score for each prompt, based on a number of new software concepts taught in each prompt, based on a number of characters in each prompt, based on a number of blank spaces for each prompt, or based on another metric for difficulty). Each prompted input may correspond to a new object class, and each object class provides an increased ability for the user to interact with or move within the environment relative to previous object classes. For example, new object classes may increase a user's speed, expand a user's range for interacting with objects in the 3D environment, or add a new piece of equipment for the user to use within the environment.

Accordingly, within examples, a computing device can create a virtual environment for teaching software coding concepts that leverages video game design in a manner that encourages user engagement. As the concepts taught to the user become more complex, the prompts may become closer to actual code used for designing the game. Further, indications of practical considerations of game design, and software development more generally (e.g., reducing memory usage or processing requirements associated with executing source code), can become part of the prompts as well. In this manner, the computing device can provide an engaging and effective way to teach coding concepts, and more specifically video game development concepts, to a user.

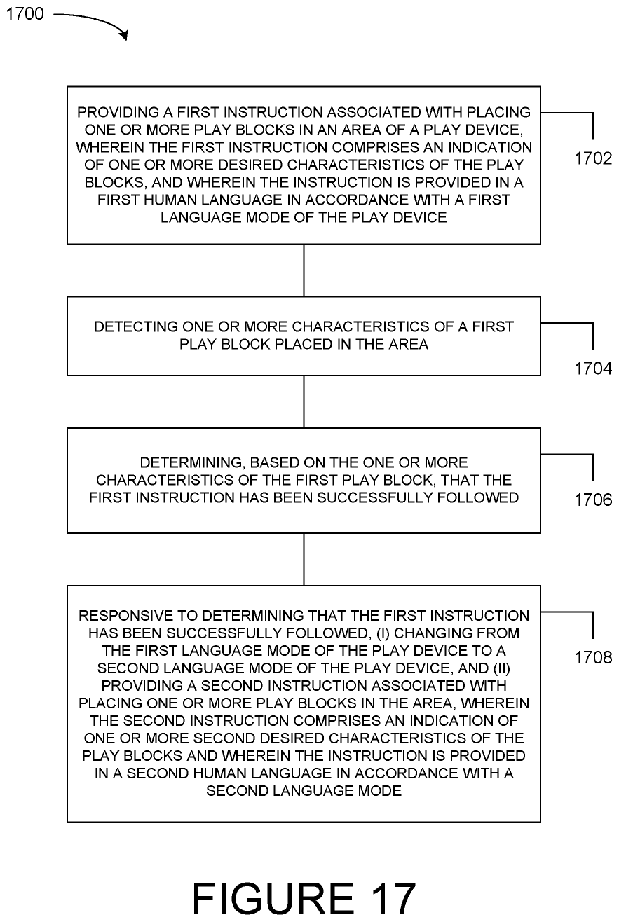

FIG. 17 is a block diagram of a method, according to an example embodiment. In particular, FIG. 17 shows a flow chart of a method 1700 for teaching language concepts. At block 1702, the method 1700 includes providing a first instruction associated with placing one or more play blocks in an area of a play device. The first instruction includes an indication of one or more desired characteristics of the play blocks (e.g., an image or word displayed on the play block), and the instruction is provided in a first human language in accordance with a first language mode of the play device. Rather than play blocks, another type of physical object could be used to interact with the play device.

At block 1704, the method 1700 includes detecting one or more characteristics of a first play block placed in the area. For example, the one or more characteristics can be detected using a sensor of the play device.

At block 1706, the method 1700 includes determining, based on the one or more characteristics of the first play block, that the first instruction has been successfully followed. For example, if the characteristics of the first play block match the desired characteristics from the instruction, the computing device may determine that the instruction has been followed.

At block 1708, the method 1700 includes, responsive to determining that the first instruction has been successfully followed, (i) changing from the first language mode of the play device to a second language mode of the play device, and (ii) providing a second instruction associated with placing one or more play blocks in the area, wherein the second instruction includes an indication of one or more second desired characteristics of the play blocks and wherein the instruction is provided in a second human language in accordance with a second language mode. In this manner, a play device can switch language modes in response to a play block being placed in the area. For example, a user can receive an instruction in a primary language, successfully follow the instruction, then can receive another instruction in a secondary language. For example, the other instruction might share one or more characteristics with the initial instruction to assist in teaching the user new words in the secondary language.

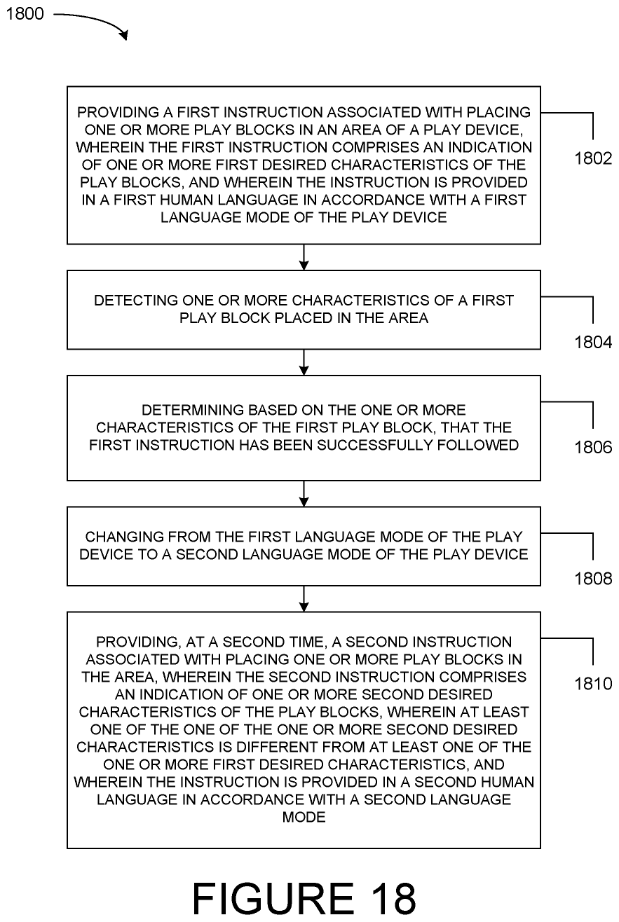

FIG. 18 is a block diagram of a method, according to an example embodiment. In particular, FIG. 18 shows a flow chart of a method 1800 for teaching language concepts. At block 1802, the method 1800 includes providing a first instruction associated with placing one or more play blocks in an area of a play device. The first instruction includes an indication of one or more first desired characteristics of the play blocks, and the instruction is provided in a first human language in accordance with a first language mode of the play device. For example, the first instruction can be provided in English. The instruction can prompt the user to find a play block with a desired characteristic such as a particular word printed on the block, a particular image, a number, a letter, or another characteristic. Rather than play blocks, another type of physical object could be used to interact with the play device.

At block 1804, the method 1800 includes detecting, by a computing device, one or more characteristics of a first play block placed in the area. For example, the one or more characteristics can be detected using a sensor of the play device.

At block 1806, the method 1800 includes determining, by the computing device based on the one or more characteristics of the first play block, that the first instruction has been successfully followed. For example, the computing device can determine that a characteristic of the play block matches the desired characteristic.

At block 1808, the method 1800 includes changing from the first language mode of the play device to a second language mode of the play device. For example, the language mode can change from an English mode to a Spanish mode.

At block 1810, the method includes, providing, at a second time, a second instruction associated with placing one or more play blocks in the area. The second instruction includes an indication of one or more second desired characteristics of the play blocks. At least one of the one of the one or more second desired characteristics is different from at least one of the one or more first desired characteristics, and the instruction is provided in a second human language in accordance with a second language mode. For example, the second instruction can be provided in Spanish, and may include change a desired characteristic to gradually teach a user of the play device different words. For example, the first instruction may prompt for a red block, while the second instruction prompts for a verde (green) block, which can encourage the user to select a different block while learning a new color in Spanish.

At block 1812 the method 1800 includes detecting, by the computing device, one or more characteristics of a second play block placed in the area.

At block 1814, the method 1800 includes determining, by the computing device based on the one or more characteristics of the second play block, that the second instruction has been successfully followed.

Within examples, no instructions are provided between the first instruction and the second instruction. This allows the language mode to change dynamically and encourages a user to interchange between two or more languages within a short span of time. In this manner, the user can learn a set of related words (e.g., numbers or colors) for multiple languages in the same lesson.

Within examples, changing from the first language mode of the play device to the second language mode of the play device includes changing from the first language mode of the play device to the second language mode of the play device responsive to determining that the first instruction has been successfully followed. For example, the play device may remain in an English mode until the first instruction is successfully followed by placing a correct play block in the area of the play device.

Within examples, the first play block is the same as the second play block. For example, the play block may be red and show the number 8. This first instruction may request a red block, and the second instruction may request an ocho (eight) block. Over multiple cycles of instructions provided in this manner, the user can infer that a different characteristic on the play block is being prompted in the second language mode, thereby assisting the user in selecting the correct play block.

Within examples, the first instruction and the second instruction each comprise an indication of a source code operator. In this manner the source code operator can serve as a common symbol in both language modes, thereby assisting the user in understanding an instruction in a secondary language. In these examples, the source code operator can be the same for the first instruction and for the second instruction.

Within examples, at least one of the one of the one or more second desired characteristics is the same as one or more of the first desired characteristics. For example, the first instruction can be for a block that is yellow and has a picture of a giraffe, and the second instruction can be for a block that is amarillo (yellow) and has a picture of a leon (lion). In this manner, the play device can gradually change which words a user learns, while encouraging the user to find different blocks to place in the play device.

### VI. OTHER VARIATIONS AND EMBODIMENTS

The systems and methods described above may be carried out by any number of components within a system that includes a disclosed play device (e.g., the play device 102). As such, it should be understood that the steps described above in relation to FIGS. 13-18 may be carried out in other ways than those explicitly disclosed. Accordingly, a system may include means for providing an instruction to perform a task. The system may include means for interacting with one or more physical objects and for evaluating the one or more physical objects to determine whether the instruction has been successfully followed. The system may further include means for providing an indication of whether the instruction has been successfully followed.

### VII. CONCLUSION

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the following claims.

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures. The above detailed description describes various features and functions of the disclosed systems, devices, and methods with reference to the Figures. In the Figures, similarly illustrated or labelled aspects typically identify similar components, unless context dictates otherwise. The example embodiments described herein and in the Figures are not meant to be limiting. Other embodiments can be utilized, and other changes can be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

A block (e.g., any block in of a block diagram of a method described herein) that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

Moreover, a block that represents one or more information transmissions may correspond to information transmissions between software and/or hardware modules in the same physical device. Other information transmissions may be between software modules and/or hardware modules in different physical devices. Furthermore, functionality of each block in a flow chart, or of any action or operation of the systems described herein, may be performed by a single computing device, a combination of computing device, or one or more computing devices operating in conjunction with mechanical, electromechanical, robotic, or other components of a system. Similarly, one or more blocks or actions or operations of systems described herein may be executed in conjunction with or based on human interaction with a system component. Moreover, any operation described as being performed by a component of the systems and devices described herein can be understood in terms of a block in a flow chart, and therefore these operations can be combined with or substitute aspects of the methods described herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A method for teaching software concepts, the method comprising:
providing an instruction to place one or more physical objects in an area of a play device, wherein the instruction comprises an indication of a source code operator;
determining, by a computing device based on sensor data from a sensor of the play device, that a physical object has been placed in the area of the play device;
responsive to determining that the physical object has been placed in the area of the play device, executing, by the computing device, an operation corresponding to the source code operator;
determining, by the computing device based on executing the operation, whether the instruction is successfully followed in accordance with the source code operator; and
providing an indication of (i) a result of executing the operation corresponding to the source code operator, and (ii) whether the instruction is successfully followed in accordance with the source code operator.

2. The method of claim 1, further comprising:
determining one or more characteristics of the physical object; and
representing the physical object by setting a value of a software object variable using the one or more characteristics,
wherein executing the operation corresponding to the source code operator comprises using the software object variable representing the physical object as an input to the software function.

3. The method of claim 2, further comprising:
providing a first visual animation on the play device that illustrates the one or more characteristics of the physical object being represented by the software object variable; and
providing a second visual animation on the play device that illustrates the software object variable representing the physical object being used as the input to the software function.

4. The method of claim 3, wherein providing the indication of the result of executing the operation corresponding to the source code operator comprises providing a visual animation of comparing a desired output of executing the operation to an output of using the software object variable representing the physical object being used as the input to the software function.

5. The method of claim 1, wherein the instruction comprises an audio indication of the source code operator and an audio indication of a desired characteristic of the physical object in connection with the source code operator, the method further comprising:
determining, by the computing device, a characteristic of the physical object after the physical object is placed in the area of the play device,
wherein executing the operation corresponding to the source code operator comprises executing the operation based on the characteristic of the physical object and wherein the result of executing the operation comprises comparing an output of executing the operation to an output associated with the desired object characteristic.

6. The method of claim 5, wherein the physical object is a play block associated with the play device, wherein the play block comprises a radio-frequency identification (RFID) tag, and wherein determining the characteristic of the physical object comprises determining the characteristic based on an identifier stored on the RFID tag.

7. The method of claim 5, wherein the physical object is a play block associated with the play device, wherein the play block comprises an identifier indicative of the characteristic, and wherein the area of the play device comprises the sensor, the method further comprising:
detecting the identifier using the sensor, wherein the sensor data represents the identifier; and
determining the characteristic based on detecting the identifier using the sensor.

8. The method of claim 7, wherein the characteristic comprises one or more of a shape of the play block, a color of the play block, or an image printed on the play block.

9. The method of claim 1, wherein the source code operator comprises an increment operator or a decrement operator, wherein the instruction comprises an instruction to place multiple physical objects in the area of the play device until reaching a desired result, and wherein executing the operation corresponding to the source code operator comprises iteratively executing an operation corresponding to the increment operator or the decrement operator, and wherein providing the indication of the result of executing the operation corresponding to the source code operator comprises providing a visual indication of an incremented or decremented output number for each physical object placed in the area of the play device.

10. The method of claim 1, wherein the source code operator comprises a logical operator, wherein the instruction comprises an instruction to place a physical object having a desired characteristic in accordance with the logical operator, and wherein executing the operation corresponding to the source code operator comprises executing the logical operator using the desired characteristic as an operand for the logical operator, and
wherein providing the indication of the result of executing the operation corresponding to the source code operator comprises providing a visual indication of a Boolean output of executing the operation corresponding to the source code operator.

11. The method of claim 1, wherein the source code operator comprises a comparison operator, wherein the instruction comprises an instruction to place a physical object having a desired characteristic in accordance with the comparison operator, and wherein executing the operation corresponding to the source code operator comprises executing the comparison operator using the desired characteristic as an operand for the comparison operator, and
wherein providing the indication of the result of executing the operation corresponding to the source code operator comprises providing a visual indication of a Boolean output of executing the operation corresponding to the source code operator.

12. The method of claim 1, wherein the source code operator comprises a mathematical operator, and wherein the instruction comprises an instruction to place a physical object having a desired numerical characteristic in accordance with the mathematical operator.

13. The method of claim 1, wherein the play device comprises a plurality of play modes, the method further comprising:
randomly selecting the source code operator for the instruction from a set of source code operators associated with a current play mode of the play device.

14. The method of claim 1, further comprising:
determining that the instruction is successfully followed in accordance with the source code operator; and
responsive to determining that the instruction is successfully followed in accordance with the source code operator, incrementing a score on the play device; and
causing the play device to dispense a new physical object (i) responsive to determining that the instruction is successfully followed in accordance with the source code operator and (ii) based on incrementing the score on the play device past a threshold score.

15. The method of claim 1, wherein the computing device is configured to operate in a plurality of language modes, and wherein, for each respective language mode:
(i) the instruction comprises a different audio instruction associated with a respective human language, and
(ii) the instruction comprises a visual indication of the source code operator that remains the same between different language modes.

16. The method of claim 1, wherein the computing device is configured to operate in a plurality of difficulty modes, wherein, in a first difficulty mode, the instruction comprises an animation illustrating a desired characteristic of the physical object and wherein, in a second mode, the instruction comprises a source code representation of the desired characteristic.

17. A play device for teaching software concepts, the play device comprising:
a sensor; and
a computing device, comprising:
one or more processors; and
a non-transitory computer readable medium having instructions stored thereon that when executed by the one or more processors cause performance of a set of functions, the functions comprising:
providing an instruction to place one or more physical objects in an area of the play device, wherein the instruction comprises an indication of a source code operator;
determining, based on sensor data from the sensor, that a physical object has been placed in the area of the play device;
responsive to determining that the physical object has been placed in the area of the play device, executing an operation corresponding to the source code operator;
determining, based on executing the operation, whether the instruction is successfully followed in accordance with the source code operator; and
providing an indication of (i) a result of executing the operation corresponding to the source code operator, and (ii) whether the instruction is successfully followed in accordance with the source code operator.

18. The play device of claim 17, wherein each physical object of the plurality of physical objects comprises an identifier, wherein the sensor is configured to detect physical objects placed in the play area based on the identifier, and wherein the functions further comprise:
storing a list of physical objects available to the play device based on detections by the sensor, wherein the list comprises one or more characteristics of each physical object; and
determining the instruction based on the list of physical objects available to the play device.

19. A system for teaching software concepts comprising:
a play device comprising an area;
a plurality of physical objects associated with the play device; and
a computing device, comprising:
one or more processors; and
a non-transitory computer readable medium having instructions stored thereon that when executed by the one or more processors cause performance of a set of functions, the functions comprising:
providing an instruction associated with placing one or more physical objects in the area of the play device, wherein the instruction comprises an indication of a source code operator;
determining, based on sensor data from a sensor of the play device, that a physical object of the plurality of physical objects has been placed in the area of the play device;
responsive to determining that the physical object has been placed in the area of the play device, executing an operation corresponding to the source code operator;
determining, by the computing device based on executing the operation, whether the instruction is successfully followed in accordance with the source code operator; and
providing an indication of (i) a result of executing the operation corresponding to the source code operator, and (ii) whether the instruction is successfully followed in accordance with the source code operator.

20. The system of claim 19, wherein the computing device is a first computing device comprised within the play device, and wherein the functions further comprise:
controlling the play device based on control instructions received from a second computing device.
